(19) United States
(12) Patent Application Publication
(10) Pub. No.: US 2005/0055250 A1
(43) Pub. Date: Mar. 10, 2005

(54) Methods and systems for computing estimated and actual accruals for a business entity

(76) Inventors: Wolfgang Kopold, Munich (DE); Markus Rump, Munich (DE); Johannes Bellert, Munich (DE); Kornelis Panman, Munich (DE)

Correspondence Address: John S. Beulick;Armstrong Teasdale LLP, One Metropolitan Square, Suite 2600, St. Louis, MO, 63102, US

(21) Appl. No.: 10/656,822

(22) Filed: Sep. 5, 2003

(51) Int. Cl. G06F 17/60

(52) U.S. Cl. 705/4

(57) ABSTRACT

A method for calculating estimated results and accruals for a business entity in accordance with predetermined accounting principles is provided. The method uses at least one accounting engine in communication with a database. The method includes storing business information in the database including at least one of accounts receivable data, accounts payable data, operating metrics, cash flow data, financial statements, capital structure, income statements, collateral data, guarantors, claims, accruals, losses, and other information relating to the financial condition of the business. The method further includes transmitting business information from the database to the at least one accounting engine, calculating at the accounting engine estimated results and accruals for the business in accordance with the predetermined accounting principles, generating entries for recording in a general ledger of the business based on the calculated estimated results and accruals, and recording the entries in the general ledger of the business.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

This invention relates generally to computing estimated and actual accruals for an insurance entity and, more particularly, to network-based methods and systems for computing estimated and actual accruals for a business entity involved in the insurance industry.

Within the United States a common set of accounting principles, standards, and procedures known as generally accepted accounting principles (U.S. GAAP) are widely recognized for financial reporting purposes. GAAP applies to external financial reporting of business enterprises. Although GAAP are a common set of accounting principles, the principles that constitute GAAP vary from product class to product class and according to the purchase status of the business.

Since GAAP apply to external financial reporting of business enterprises, GAAP is also applicable to business entities involved in the insurance and re-insurance industry. More specifically, pursuant to U.S. GAAP, a business entity involved in the insurance or re-insurance industry in the United States should comply with U.S. GAAP when preparing and reporting its financial statements. Therefore, these same business entities should be able to calculate estimated results on single insurance contracts and contract portfolios, and calculate the appropriate quarterly accruals in accordance with U.S. GAAP accounting requirements. Accordingly, the business entity must calculate earning of premiums, commissions, and losses for various kinds of contracts and business transactions. Failure to comply with U.S. GAAP may expose the business entity to financial losses, monetary penalties, and/or criminal penalties.

The tasks associated with an insurance entity complying with the reporting requirements of U.S. GAAP may be time-consuming and often take away resources of the business entity from its operations and other profitable activities. Completing several of these tasks also typically requires interfacing with outside professionals such as lawyers and accountants.

### BRIEF DESCRIPTION OF THE INVENTION

In one aspect, a method for calculating estimated results and accruals on at least one insurance contract in accordance with predetermined accounting principles is provided. The method uses a plurality of accounting engines in communication with a database. The method includes the step of storing insurance information in the database wherein the insurance information relates to the at least one insurance contract issued by an insurer to an insured, and includes information relating to at least one of premiums, commissions, insurance policies, contracts, accounting bookings, claims, accruals, and losses. The method further includes the steps of transmitting insurance information from the database to the plurality of accounting engines, calculating at the accounting engines estimated results and accruals for the at least one insurance contract in accordance with the predetermined accounting principles, generating entries for recording in a general ledger of the insurer based on the calculated estimated results and accruals, and recording the entries in the general ledger of the insurer.

In another aspect, a system for calculating estimated results and accruals on at least one insurance contract in accordance with predetermined accounting principles is provided. The system includes a database for storing insurance information relating to the at least one insurance contract issued by an insurer to an insured, and to at least one of premiums, commissions, insurance policies, contracts, accounting bookings, claims, accruals, and losses. The system also includes a plurality of accounting engines in communication with the database. The accounting engines are configured to receive insurance information from the database, calculate estimated results and accruals for the at least one insurance contract in accordance with the predetermined accounting principles, generate entries for recording in a general ledger of the insurer based on the calculated estimated results and accruals, and record the entries in the general ledger of the insurer.

In another aspect, a computer program embodied on a computer readable medium for calculating estimated results and accruals on at least one insurance contract in accordance with predetermined accounting principles is provided. The program includes a code segment that receives insurance information and then maintains a database by adding, deleting and updating insurance information relating to the at least one insurance contract issued by an insurer to an insured, and to at least one of premiums, commissions, insurance policies, contracts, accounting bookings, claims, accruals, and losses. The code segment also supports a plurality of accounting engines that receive insurance information from the database, calculates estimated results and accruals for the at least one insurance contract in accordance with the predetermined accounting principles, generates entries for recording in a general ledger of the insurer based on the calculated estimated results and accruals, and records the entries in the general ledger of the insurer.

In another aspect, a method for calculating estimated results and accruals for a business entity in accordance with predetermined accounting principles is provided. The method uses at least one accounting engine in communication with a database. The method includes storing business information in the database including at least one of accounts receivable data, accounts payable data, operating metrics, cash flow data, financial statements, capital structure, income statements, collateral data, guarantors, claims, accruals, losses, and other information relating to the financial condition of the business. The method further includes transmitting business information from the database to the at least one accounting engine, calculating at the accounting engine estimated results and accruals for the business in accordance with the predetermined accounting principles, generating entries for recording in a general ledger of the business based on the calculated estimated results and accruals, and recording the entries in the general ledger of the business.

In another aspect, a system for calculating estimated results and accruals for a business entity in accordance with predetermined accounting principles is provided. The system includes a database for storing business information including at least one of accounts receivable data, accounts payable data, operating metrics, cash flow data, financial statements, capital structure, income statements, collateral data, guarantors, claims, accruals, losses, and other information relating to the financial condition of the business. The system also includes at least one accounting engine in communication with the database. The accounting engine is configured to receive business information from the database, calculate estimated results and accruals for the business in accordance with the predetermined accounting principles, generate entries for recording in a general ledger of the business based on the calculated estimated results and accruals, and record the entries in the general ledger of the business.

### BRIEF DESCRIPTION OF THE DRAWINGS

FIG. 1 is a simplified block diagram of an Accounting Engine Coordination System (AECS) in accordance with one embodiment of the present invention.

FIG. 2 is an expanded version block diagram of an example embodiment of a server architecture of the AECS.

FIG. 3 is a block diagram illustrating an example embodiment of a logical architecture included within an AECS.

FIG. 4 is a block diagram illustrating an example embodiment of accounting engine modules included within an AECS.

FIG. 5 is a graph illustrating an example embodiment of written and earned premiums distributed over a unique pattern for an AECS.

FIG. 6 is a flowchart illustrating example processes of inputting actual bookings, premium estimations, and loss estimations into an AECS.

FIG. 7 is a block diagram illustrating a calculation of premiums, losses and other functionality performed by an AECS.

FIG. 8 is a flowchart illustrating example processes utilized by a Status Change Module (SCM) included within an AECS.

FIG. 9 is a is a more detailed flowchart illustrating example processes utilized by Status Change Module (SCM) included within an AECS.

FIGS. 10A and 10B show a flowchart illustrating example processes utilized by a RIP/RIOS Module included within an AECS.

FIG. 11 is a flowchart illustrating example processes utilized by an IBNR Module included within an AECS.

### DETAILED DESCRIPTION OF THE INVENTION

Example embodiments of systems and processes that facilitate integrated network-based electronic reporting and workflow process management related to an Accounting Engine Coordination System (AECS) are described below in detail. A technical effect of the systems and processes described herein include at least one of facilitating an electronic submission of information using a client system, automating extraction of information, web-based reporting for internal and external system users, calculating estimated results on single insurance contracts and contract portfolios, calculating appropriate quarterly accruals, and facilitating compliance with the reporting requirements of U.S. generally accepted accounting principles (GAAP) for a business entity involved in the insurance industry. Moreover, the AECS allows an insurance entity to collect, manage, store, calculate, and disseminate accounting engine (AE) information among internal users and selected outside users to facilitate a more accurate and efficient compliance with the reporting requirements of U.S. GAAP.

The AECS includes a plurality of accounting engine modules (also known as accounting engines) including at least one of a Status Change Module, an Unearned Premium (UEP) Module, a Commissions Module, a Reinstatement Premium/Reinstatement Outstanding (RIP/RIOS) Module, an Attritional Loss Module, a Catastrophic Loss Module, and an Incurred But Not Reported (IBNR) Module. The accounting engine modules calculate estimated results on single contracts and portfolios, and appropriate quarterly accruals in accordance with U.S. GAAP accounting requirements and record the entries in a general ledger.

More specifically, the AECS is a U.S. GAAP accounting tool for an insurance business which enables the calculation of estimated results on single contracts and portfolios, and the appropriate quarterly accruals in accordance with U.S. GAAP accounting requirements. The AECS utilizes the concepts of the earning of premiums, commissions, and losses for various kinds of contracts and business transactions in performing such calculations.

In the example embodiment, the AECS calculates premium earning patterns, commission earning patterns, and losses to comply with the reporting requirements of U.S. GAAP. Premium earning patterns include “normal” and loss related premium components. The “normal” premium components are part of an Estimated Premium Income (EPI) which represents the basis for the quarterly accruals. The EPI includes a Minimum and Deposit (M&D) premium and an Adjustment premium. The loss related premium components include a Reinstatement Premium (RIP) and a Reinstatement Outstanding (RIOS). Reinstatements (R's) are triggered by incurred losses. Commission earning patterns include a brokerage/overrider commission, a profit commission, and a no claims bonus commission.

Loss earning patterns include attritional and catastrophe business losses. Attritional losses are all losses which are not defined as catastrophic losses. An Incurred But Not Reported (IBNR) tool and a loss estimation tool are required to estimate attritional losses on a portfolio level. The AECS also differentiates between the following loss reserves: (i) booked (cedant) reserves per contract; (ii) estimated attritional loss reserves; (iii) event IBNR's; and (iv) actuarial EBNR's not on contract level but on portfolio level. Catastrophic losses are large losses effecting more than one insurance contract.

The AECS also includes a true up/status change functionality. The basic idea of a status change functionality within the AECS is that estimated numbers are replaced by real accounted numbers as soon as the real accounted numbers are reliable and booked within the operating system.

The AECS also calculates retrocessions. There are generally two types of retrocessions: a proportional retrocession, and a non-proportional retrocession. A proportional retrocession is directly linked to inward contracts. Therefore, the U.S. GAAP accruals for a proportional retrocession are calculated based on the respective inward numbers. The earning of non-proportional retrocession contracts are independent from the inward contracts as far as premiums and commissions are concerned.

In the AECS, AE information is stored in a database. The network based AECS provides convenient access to AE information. A user must be authorized to gain access into the AECS.

In one embodiment, the system is a computer program embodied on a computer readable medium implemented utilizing Java® and Structured Query Language (SQL) with a client user interface front-end for administration and a web interface for standard user input and reports. (Java is a registered trademark of Sun Microsystems, Inc., Palo Alto, Calif.). In an example embodiment, the system is web enabled and is run on a business-entity's intranet. In yet another embodiment, the system is fully accessed by individuals having an authorized access outside the firewall of the business-entity through the Internet. In a further example embodiment, the system is being run in a Windows® NT environment (Windows is a registered trademark of Microsoft Corporation, Redmond, Wash.). The application is flexible and designed to run in various different environments without compromising any major functionality.

The systems and processes are not limited to the specific embodiments described herein. In addition, components of each system and each process can be practiced independent and separate from other components and processes described herein. Each component and process also can be used in combination with other assembly packages and processes.

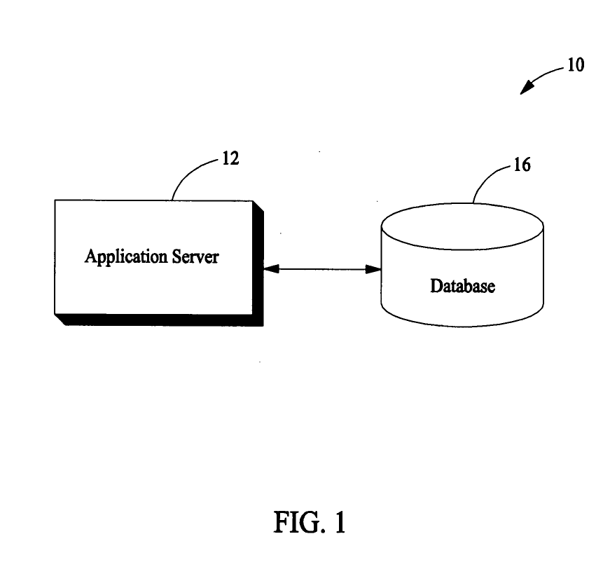

FIG. 1 is a simplified block diagram of an Accounting Engine Coordination System (AECS) 10 including an application server system 12, and a centralized database 16 connected to application server system 12. Database 16 contains information on a variety of matters as described below in greater detail. In one embodiment, application server system 12 is connected to database 16 through a data access layer which enables data to be communicated between application server system 12 and database 16. In the example embodiment, system 10 utilizes batch processing and an automated job scheduler when communicating data between application server 12 and database 16.

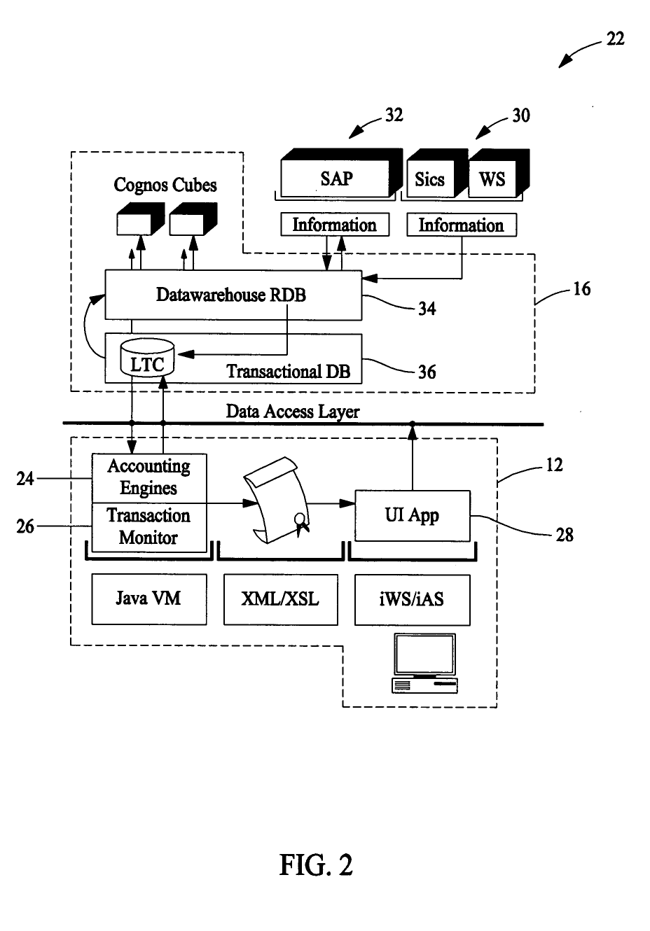

FIG. 2 is an expanded version block diagram of an example embodiment of a server architecture of an AECS 22. Components in system 22, identical to components of system 10 (shown in FIG. 1), are identified in FIG. 2 using the same reference numerals as used in FIG. 1. System 22 includes application server system 12 and database 16. Application server system 12 further includes accounting engine modules 24, a transaction monitor 26, and a user interface application module 28. Accounting engine modules 24 are in communication with transaction monitor 26, and are in communication with user interface application module 28. In the example embodiment, accounting engine modules 24 communicate with user interface application module 28 through an extensible markup language (XML) and an extensible stylesheet language (XSL).

A contract administration operating system 30, and a general ledger system 32 are in communication with database 16. Database 16 is a datawarehouse that includes a Reporting Database (RDB) 34, and a Transactional Database 36. Operating system 30 processes and stores information including: all reported cedant figures, Estimated Premium Income (EPI), Commission Ratio (Calculated), and Loss Ratio (Calculated). In the example embodiment, operating system 30 is a commercially available operating system known as a Writasure Operating System. (The Writasure Operating System is manufactured and supported by RebusIS, London, UK.) Operating system 30 is in communication with RDB 34 and provides information to RDB 34. RDB 34 is in communication with Transactional Database 36. Information is communicated back and forth between RDB 34 and Transactional Database 36.

General ledger system 32 is also in communication with RDB 34. In the example embodiment, general ledger system 32 is a commercially available system manufactured by SAP® (SAP is a registered trademark of SAP Aktiengesellschaft, Walldorf, Germany).

Transactional Database 36 is in communication with accounting engine modules 24 through a data access layer. Information is provided through Transactional Database 36 to accounting engine modules 24. Accounting engine modules 24 utilize the provided information to calculate estimated results on single contracts and portfolios, and appropriate quarterly accruals in accordance with U.S. GAAP accounting requirements. The results are validated and recorded in general ledger system 32.

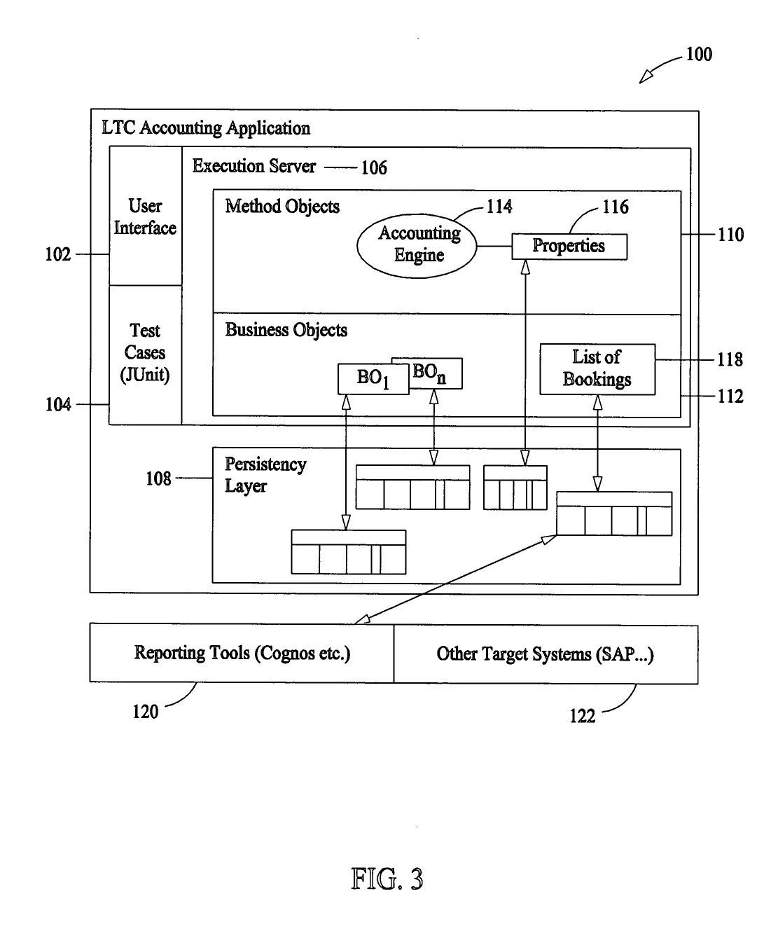

FIG. 3 is a block diagram of an example embodiment of a logical architecture 100 included within AECS 10 (shown in FIG. 1). Logical architecture 100 includes a user interface 102, a Test Cases (JUnit) 104, an Execution Server 106, and a Persistency layer 108. Execution Server 106 includes a Method Objects layer 110, and a Business Objects layer 112. Method Objects layer 110 further includes at least one accounting engine 114, and Accounting Engine Properties 116. Business Objects layer 112 also includes a List of Bookings 118. In the example embodiment, Execution Server 106 is in communication with Persistency layer 108.

Logical architecture 100 also includes reporting tools 120, and other target systems 122. In the example embodiment, Persistency layer 108 is in communication with reporting tools 120, and other target systems 122.

In the example embodiment, a data warehouse provides well specified input views and tables for the computed bookings. A plurality of different accounting engines may be “plugged in” on Method Objects layer 110. Each type of accounting engine is predefined by an interface. A rapid-development of accounting engine implementations is possible without impacts to the platform. In the example embodiment, Test Cases (JUnit) 104 realize the setup of AECS 10, start accounting engines 114, test results, and are involved in the tear down of the input test data (regression tests).

In the example embodiment, users may wish to save their accounting engine test run with all input and result data sets. The persistency of the whole test scenario is named as an image. Images can be reloaded and restarted. The referenced result set could be used for comparisons. More specifically, an image may include the following determining entities: (1) an accounting engine which includes an “algorithm” run by the Execution Server (e.g., LTC-RIOS); (2) Accounting Engine Properties which includes the parameters used for a specific run of an accounting engine; (3) input data set which is data set on which the accounting calculations are performed; (4) result set which is an output produced in a run of an accounting engine; and (5) image description which includes a categorization of the scenario run including at least one of user name and timestamp, and test assertions.

Persistency layer 108 is a layer of classes that provide access to underlying databases. Persistency layer 108 enables the system to connect to different database schemas such that different accounting engines may work on different data sets. Persistency layer 108 accesses separate databases that contain all the necessary data for the accounting calculations as fetched from the data warehouse. This ensures that all calculations and modification may be performed without affecting the original data.

Execution Server 106 provides the functionality needed by an accounting engine for operation. Execution Server 106 is where the different accounting engines are plugged-in. Execution Server 106 enables a user to manage accounting engines 114, and user workspace images. Accounting engines 114 include certain accounting calculation tasks or algorithms. Business Objects layer 112 is used by accounting engines 114 to access data sets.

User interface 102 is utilized by a user to start Test Cases on DOS command prompts. User interface 102 enables a user to define/load/store an image, run an accounting engine/image, set properties of an accounting engine, and compare result sets. Test Cases 104 act as a client of Execution Server 106.

In the example embodiment, the data warehouse stores insurance and accounting information for a business entity that provides insurance related services to its clients. The insurance and accounting information (collectively referred to herein as Accounting Engine information or AE information) includes information relating to premiums, commissions, insurance policies, contracts, accounting bookings, claims, accruals, and losses. The data warehouse may be divided into a Business Contract Header Section, a Business Additional Worksheet Section, and an Accounting Detail Section. The Business Contract Header Section includes information relating to at least one of: Cedant Name, Contract Number, Currency, and Date. The Business Additional Worksheet Section includes information relating to at least one of: Class Codes, Contract Number, Estimated Premium Income (EPI), and claim Limit. The Accounting Detail Section includes accounting details (i.e., bookings) for at least one contract and a portfolio of contracts.

System 10 accumulates a variety of confidential data and has different access levels to control and monitor the security of and access to system 10. Authorization for access is assigned by system administrators on a need to know basis. In one embodiment, access is provided based on job functions. In yet another embodiment, system 10 provides access based on business-entity. The administration/editing capabilities within system 10 are also restricted to ensure that only authorized individuals have access to modify or edit the data existing in the system. System 10 manages and controls access to system data and information.

The architectures of system 10 as well as various components of system 10 are exemplary only. Other architectures are possible and can be utilized in connection with practicing the processes described below.

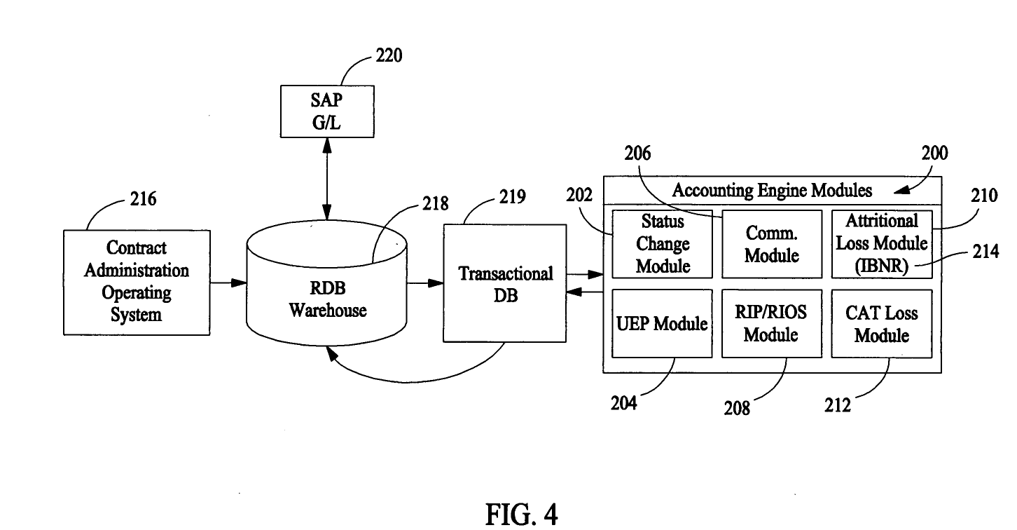

FIG. 4 is a block diagram illustrating accounting engine modules 200 included within AECS 10 (shown in FIG. 1). In the example embodiment, accounting engine modules 200 include at least one of a Status Change Module 202, an Unearned Premium (UEP) Module 204, a Commissions Module 206, a Reinstatement Premium/Reinstatement Outstanding (RIP/RIOS) Module 208, an Attritional Loss Module 210, and a Catastrophic Loss Module 212. Attritional Loss Module 210 also includes an Incurred But Not Reported (IBNR) Module 214.

AECS 10 also includes a contract administration operating system 216, a Reporting Database (RDB) 218, and a Transactional Database 219. Operating system 216 processes and stores information including: all reported cedant figures, Estimated Premium Income (EPI), Commission Ratio (Calculated), and Loss Ratio (Calculated). In the example embodiment, operating system 216 is a commercially available operating system know as a Writasure Operating System. (The Writasure Operating System is manufactures and supported by RebusIS, London, UK.) Operating system 216 is in communication with RDB 218 and provides AE information to RDB 218. RDB 218 is in communication with accounting engine modules 200 though Transactional Database 219 and provides AE information to accounting engine modules 200. Accounting engine modules 200 calculate estimated results on single contracts and portfolios, and appropriate quarterly accruals in accordance with U.S. GAAP accounting requirements and records the entries in an SAP® general ledger 220 via RDB 218. (SAP is a registered trademark of SAP Aktiengesellschaft, Walldorf, Germany.)

In the example embodiment, AECS 10 is a U.S. GAAP accounting tool for an insurance business which enables the calculation of estimated results on single contracts and portfolios, and the appropriate quarterly accruals in accordance with U.S. GAAP accounting requirements. AECS 10 utilizes the concepts of the earning of premiums, commissions and losses for various kinds of contracts and business transactions. These concepts are discussed below in more detail.

1. Premium Earning Pattern.

A separation between “normal” and loss related premium components is necessary when utilizing AECS 10. The “normal” premium components should be part of the Estimated Premium Income (EPI) which represents the basis for the quarterly accruals. The EPI includes a Minimum and Deposit (M&D) premium and an Adjustment premium.

The M&D premium is a risk related turnover, which has to be earned over the risk period (i.e., matching principle). This information is available on a contract level and on a section level. Earning an M&D premium is dependent on: (i) contract period (i.e., normally one year); (ii) type of contract including facultative, non-proportional (XoL), and proportional; (iii) risk basis including Loss Occurring During (LOD), and Loss Occurring Risk Attaching (LORA); and (iv) remaining coverage. With respect to a M&D premium, the premium must be fully earned when the cover is exhausted. For a LORA business, the premium earning curve is an S-curve over a two year risk period.

Adjustment premiums are premium components for non-proportional contracts which adjust the M&D premium to the total premium. Adjustment premiums are usually calculated as a percentage of the original premium of the cedant. The Adjustment premiums are part of the ultimate EPI estimation of the underwriter on a contract level. An Adjustment premium is earned over a risk period. The M&D premium earning rules also apply to an Adjustment premium.

For purposes of illustration, examples of the different earning patterns are shown below.

### EXAMPLE 1

XoL LOD contract Inception January, 1st
EPI 100 USD

| | | | | | | Total |
|---|---|---|---|---|---|---|
| | | Q1 | Q2 | Q3 | Q4 | Year 1 |
| P&L | Written Premium | (25) | (25) | (25) | (25) | (100) |
| | Change in unearned | 0 | 0 | 0 | 0 | 0 |
| BS | Premium Receivables | 25 | 25 | 25 | 25 | 100 |
| | Unearned Premium | 0 | 0 | 0 | 0 | 0 |

### EXAMPLE 2

XoL LORA contract Inception January, 1st
EPI 100 USD

| | | Q1 | Q2 | Q3 | Q4 | |
|---|---|---|---|---|---|---|
| | | | | | | Total |
| | | | | | | Year 1 |
| P&L | Written Premium | (25) | (25) | (25) | (25) | (100) |
| | Change in unearned | 3 | 9 | 16 | 22 | 50 |
| BS | Premium Receivables | 25 | 25 | 25 | 25 | 100 |
| | Unearned Premium | (3) | (9) | (16) | (22) | (50) |
| | | | | | | Total |
| | | | | | | Year 2 |
| P&L | Written Premium | 0 | 0 | 0 | 0 | 0 |
| | Change in unearned | (22) | (16) | (9) | (3) | (50) |
| BS | Premium Receivables | 0 | 0 | 0 | 0 | 0 |
| | Unearned Premium | 22 | 16 | 9 | 3 | 50 |

### EXAMPLE 3

Facultative contract Inception January, 1st
EPI 100 USD

| | | | | | | Total |
|---|---|---|---|---|---|---|
| | | Q1 | Q2 | Q3 | Q4 | Year 1 |
| P&L | Written Premium | (100) | 0 | 0 | 0 | (100) |
| | Change in unearned | 75 | (25) | (25) | (25) | 0 |
| BS | Premium Receivables | 100 | 0 | 0 | 0 | 100 |
| | Unearned Premium | (75) | 25 | 25 | 25 | 0 |

### EXAMPLE 4

Proportional contract (LORA) Inception January, 1st
EPI 100 USD

| | | Q1 | Q2 | Q3 | Q4 | |
|---|---|---|---|---|---|---|
| | | | | | | Total |
| | | | | | | Year 1 |
| P&L | Written Premium | (25) | (25) | (25) | (25) | (100) |
| | Change in unearned | 3 | 9 | 16 | 22 | 50 |
| BS | Premium Receivables | 25 | 25 | 25 | 25 | 100 |
| | Unearned Premium | (3) | (9) | (16) | (22) | (50) |
| | | | | | | Total |
| | | | | | | Year 2 |
| P&L | Written Premium | 0 | 0 | 0 | 0 | 0 |
| | Change in unearned | (22) | (16) | (9) | (3) | (50) |
| BS | Premium Receivables | 0 | 0 | 0 | 0 | 0 |
| | Unearned Premium | 22 | 16 | 9 | 3 | 50 |

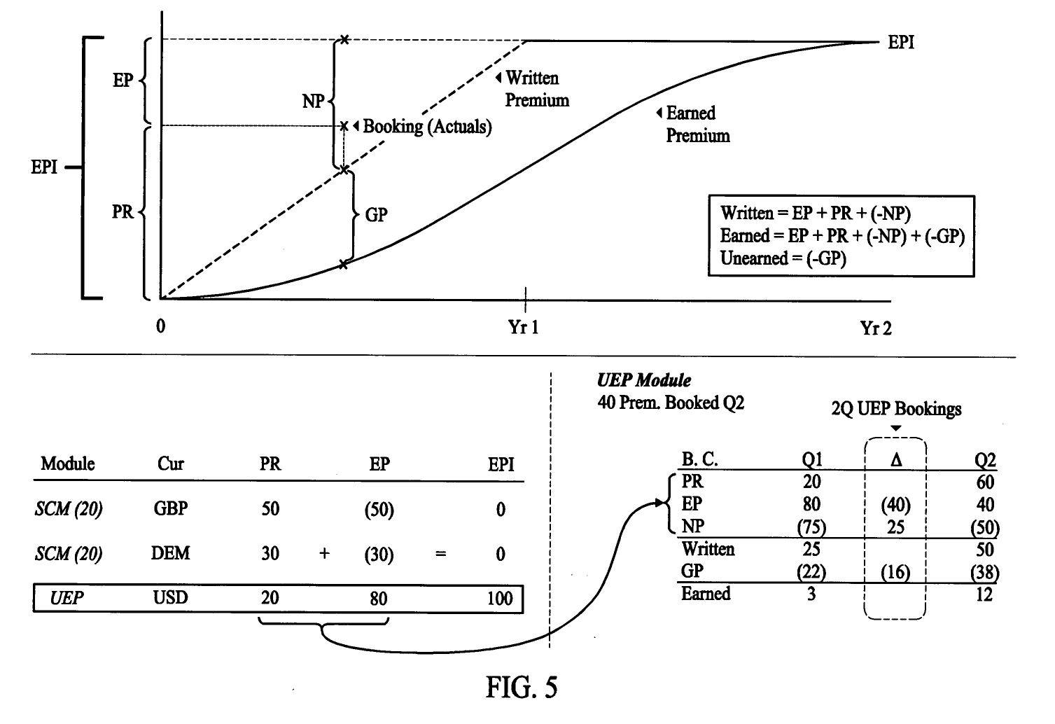

For purposes of further illustration, FIG. 5 illustrates an example embodiment of written and earned premiums distributed over a unique pattern.

The loss related premium components include a Reinstatement Premium (RIP) and a Reinstatement Outstanding (RIOS). Reinstatements (RIs) are triggered by incurred losses. Therefore, RIs are earned at the same time the related loss is recorded. Future premium earning patterns (i.e., earning of EPI) are not effected by RIs, as the covered future risk does not change. With respect to RIPs, there are no estimations but only accounted numbers.

RIOS are calculated on the following types of loss reserves: (i) RIOS calculation based on booked (cedant) reserves per contract, (ii) RIOS calculation based on estimated attritional loss reserves, (iii) RIOS calculation based on event IBNR's (booked on dummy contracts), and (iv) RIOS calculation based on actuarial IBNR's not on contract level but on a portfolio (e.g., Facultative Aviation Europe, etc.) or segment level (booked on dummy contracts). Different RIOS types are identified (coded) separately within AECS 10. RIOS may be calculated in a variety of ways. RIOS on cedant reserves may be calculated using a “per contract RIOS calculator” because the loss information is directly available on a contract level. For the RIOS on other reserve types which are not directly available on a contract level there are two possible calculation methods: (a) application of a ratio (current percentage from RIOS calculator) on reserve amount per segment dummy contract; and (b) allocation of the reserves to the contract level. The RIOS may then be calculated using the “per contract RIOS calculator” again. For example:

XL LOD contract
M&D 100 USD
200 xs 50
1 RI @ 80 USD

| | Q1 | Q2 | Q3 | Q4 | Total |
|---|---|---|---|---|---|
| Loss free | | | | | |
| WP/EP | 25 | 25 | 25 | 25 | 100 |
| EPI = 100 | | | | | |
| Loss | ./. | ./. | ./. | ./. | 0 |
| No LR Contract Estimate | 25 | 25 | 25 | 25 | 100 |
| Loss 200 USD Q3 | | | | | |
| UW adjusts EPI to 180? | | | | | |
| WP/EP | 25 | 25 | 105 | 25 | 180 |
| Loss | ./. | ./. | −200 | ./. | −200 |
| | 25 | 25 | −95 | 25 | −20 |

The loss related premium components also include a Loss Additional Premium. Similar to RIs, Additional Premiums are loss related and should be earned with the incurred loss. No additional cover is triggered with this premium. Estimations are not utilized for Additional Premiums, and only accounted numbers are recognized.

2. Commission Earning Pattern.

A separation between commission components is also necessary within AECS 10. The commission components include brokerage/overrider commission, profit commission, and no claims bonus commission.

Expenses deriving out of efforts in signing business (i.e., acquisition costs) can be debited within the balance. Deferred Acquisition Costs (DAC) will be expensed/amortized in the same way the premium will be earned. This information is available on a contract level within AECS 10.

A profit commission (non-proportional) is a profit share agreement with the cedant. It has to be calculated and earned according to the current estimated result of the contract. A profit commission is calculated on a contract level, and the calculation is based only on a quarterly accrued underwriters ultimate estimation. If significant information is not available, the profit commission must be estimated quarterly by the underwriter.

A no claims bonus (non-proportional) is a profit share agreement with the cedant. A repayment becomes due if no claim occurred on the contract. It has to be calculated and earned as a percentage of the current earned premium according to the terms of the contract. A no claims bonus is calculated on a contract level, and the calculation is based only on a quarterly underwriters loss estimation.

3. Loss Earning Pattern.

A separation between attritional and catastrophe business losses is also necessary within AECS 10.

Attritional losses are all losses which are not defined as catastrophic losses. For proportional business, attritional losses are estimated (loss ratio) on a contract level. For facultative and non-proportional business, attritional losses are estimated (loss ratio) on a portfolio/lossyear level with allocation to individual contracts by premium amounts or loss estimation on contract level directly. An Incurred But Not Reported (IBNR) tool and a loss estimation tool are required to estimate attritional losses on a portfolio level.

AECS 10 also differentiates between the following loss reserves (i.e., separate coding necessary): (i) booked (cedant) reserves per contract; (ii) estimated attritional loss reserves; (iii) event IBNR's; and (iv) actuarial IBNR's not on contract level but on portfolio level. Estimated attritional loss reserves are either directly estimated on a contract level (proportional business) or on a portfolio level.

Catastrophic losses are losses that are defined per portfolio as follows: every event with an OML (Original Market Loss) greater than “X” and/or a UNL (Ultimate Net Loss) greater than “X”. With respect to catastrophic losses, estimations are not possible, and losses are accounted when they occur.

4. True Up/Status Change Functionality.

The status change functionality enables a user to replace estimated numbers included within AECS 10 with real accounted numbers as soon as the real accounted numbers are reliable and booked within operating system 216. In the example embodiment, the status of a contract within AECS 10 will be review by an underwriter if one of the following criteria are met: (i) the risk period must be over by one month; (ii) the last installment and the fourth quarter account have been booked; or (iii) contract is commuted or canceled.

5. Retrocession.

There are generally two types of retrocessions: a proportional retrocession, and a non-proportional retrocession.

A proportional retrocession is directly linked to inward contracts. Therefore, the U.S. GAAP accruals for a proportional retrocession are calculated based on the respective inward numbers. A separate specification of an EPI or combined ratio on a proportional outward contract is not necessary.

There are two different types of proportional retrocessions: Quota Shares & Surpluses, and Proportional Facultative Reinsurance. A Quota Share retrocedes a pool of inward contracts by applying a share percentage on the pool premiums and losses. The pool has to then be placed at the market, but it all does not necessarily have to be placed. Quota shares with different share percentages on the inward contracts are called surpluses. A proportional facultative reinsurance (FAC RI) is a pro-rata reinsurance contract on a single inward contract.

Both types of retrocessions are based on inward contracts. In the example embodiment, it is mandatory that the respective inward contracts are sufficiently coded (i.e., the assignment to a certain pool or FAC RI, the quota share per inward contract, and the placement percentage need to be clearly defined).

The general rule is that premiums are calculated based on the premiums of the connected inward contracts according to the following formula:
Inward EPI*Ceded Percentage*Placement Percentage=Outward EPI

For quarterly accounting, this formula is applied on a quarterly written and unearned premium. Additionally, the earning is dependent on whether the retrocession contract itself is underwriting year (LORA) or loss year (LOD) based. The risk period for a one year LOD proportional retrocession contract always ends after one year.

Proportional outward contracts might have an agreed M&D premium. In such a case, the M&D premium would be earned separately. In addition, only the exceeding part of the calculated retro EPI would be earned. In order to consider those cases, an additional function is implemented: if retro M&D premium is greater than the calculated retro EPI, then the M&D premium is calculated according to inward earning rules instead of applying the calculation rules described above.

The recoveries are calculated based on the inward contracts according to the premium calculation:
Inward Loss*Ceded Percentage*Placement Percentage=Outward Recovery

The commission provisions of proportional retro-contracts are usually independent from the inward contracts. For this reason, the earning of the commissions can not be based on inward numbers but has to be calculated separately. The earning of non-proportional retrocession contracts are independent from the inward contracts as far as premiums and commissions are concerned. For the earning of the premiums and commissions, the inward logic can be applied. The outward losses (recoveries) are calculated per contract based on the inward loss information.

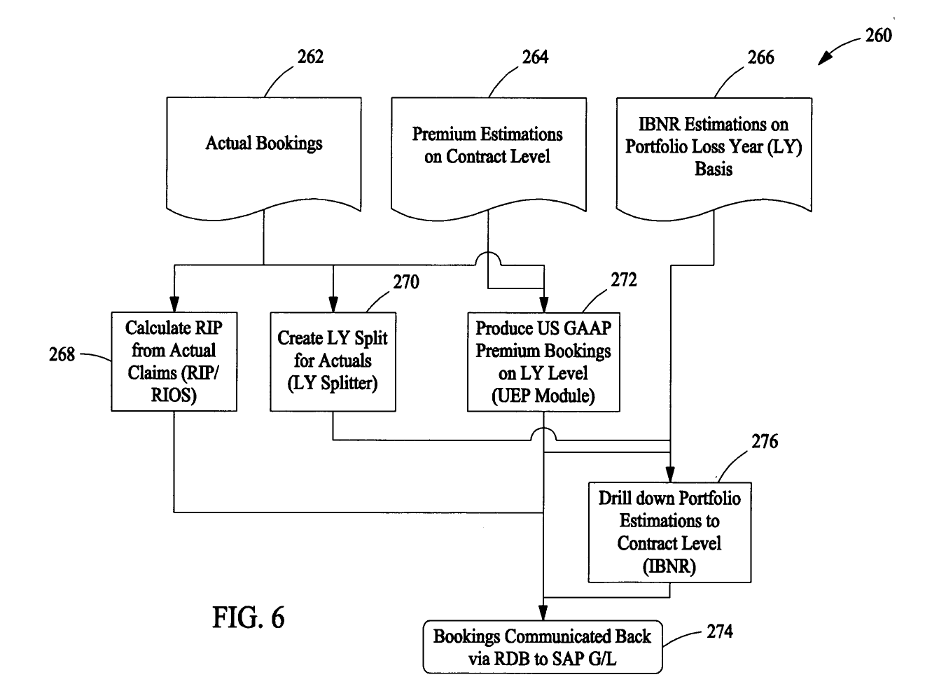

FIG. 6 is a flowchart 260 illustrating example processes of inputting actual bookings 262, premium estimations 264, and loss estimations 266 into AECS 10 (shown in FIG. 1). In the example embodiment, actual bookings 262 are entered into AECS 10. Actual bookings 262 may be processed by calculating 268 a reinstatement premium (RIP) from the actual claims using Reinstatement Premium/Reinstatement Outstanding (RIP/RIOS) Module 208 (shown in FIG. 4), creating 270 a loss year (LY) split for the actual claims, and producing 272 U.S. GAAP premium bookings on a LY level using UEP Module 204 (shown in FIG. 4). The RIP calculations are then communicated 274 back to SAP® general ledger 220 (shown in FIG. 4) via RDB 218 (shown in FIG. 4). The LY split for actual bookings and the premium bookings are communicated to IBNR Module 214 (shown in FIG. 4) for drilling down 276 portfolio estimations to a contract level. These calculations are then communicated 274 back to SAP® general ledger 220 via RDB 218.

Premium estimations 264 are communicated to UEP Module 204 for producing 272 U.S. GAAP premium bookings on a LY level. The premium bookings are then communicated to IBNR Module 214 for drilling down 276 portfolio estimations to a contract level. These calculations are then communicated 274 back to SAP® general ledger 220 via RDB 218.

Loss estimations 266 are communicated to IBNR Module 214 for drilling down 276 portfolio estimations to a contract level. These calculations are then communicated 274 back to SAP® general ledger 220 via RDB 218.

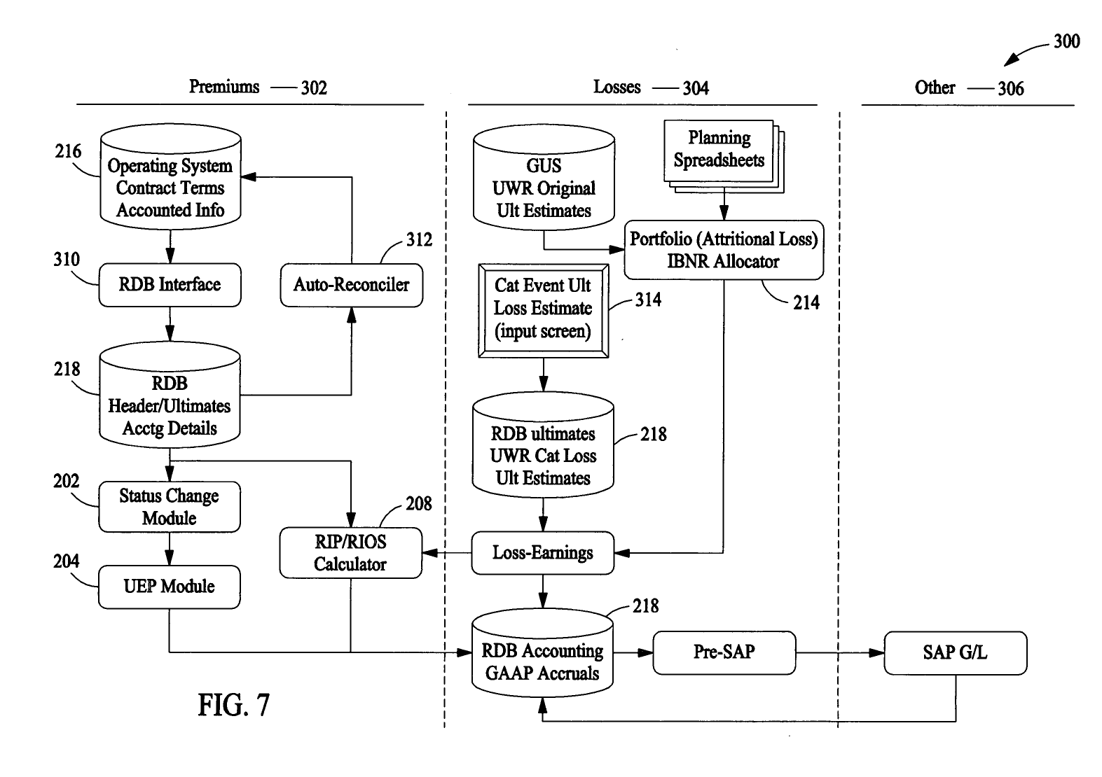

FIG. 7 is a block diagram 300 illustrating a calculation of premiums, losses and other functionality performed by AECS 10 (shown in FIG. 1). In the example embodiment, accounting engine modules 200 (shown in FIG. 4) can be categorized into three (3) segments: Premiums 302, Losses 304, and Other 306. Premiums are calculated utilizing AECS 10 by first transmitting information including contract terms and accounting information from operating system 216 through an RDB (Reporting Database) Interface 310 to RDB 218. The information transmitted, including accounting details, is then transmitted to an auto reconciler 312 so that the information exchanged between operating system 216 and RDB 218 may be reconciled between these two systems. If AECS 10 then determines that a status change has occurred with a contract, information stored in RDB 218 is transmitted to Status Change Module 202, which in turn communicates with Unearned Premium (UEP) Module 204. The earning calculations are then stored on RDB 218 in an accounting detail section. If, however, AECS 10 determines that no status change has occurred, information stored in RDB 218 is transmitted to Reinstatement Premium/Reinstatement Outstanding (RIP/RIOS) Module 208. These calculations are then stored on RDB 218 in the accounting detail section.

Losses are calculated utilizing AECS 10 by first determining whether a loss is an attritional loss or a catastrophic loss. An attritional loss is processed using Attritional Loss Module 210 (shown in FIG. 4), which includes IBNR Module 214. Loss earnings are then communicated to RIP/RIOS Module 208 so that the information may be processed and stored in RDB 218. Catastrophic losses include a loss estimate 314, which is transmitted to RDB 218 so that the loss earnings may be calculated and then processed by RIP/RIOS 208. The premiums and losses are then stored on a general ledger of the business entity.

As discussed above, AECS 10 includes a plurality of accounting engine modules. The accounting engine modules include at least a Status Change Module, an Unearned Premium (UEP) Module 204, and a Reinstatement Premium/Reinstatement Outstanding (RIP/RIOS) Module 208. Each these modules will be discussed below in detail.

I. Status Change Module

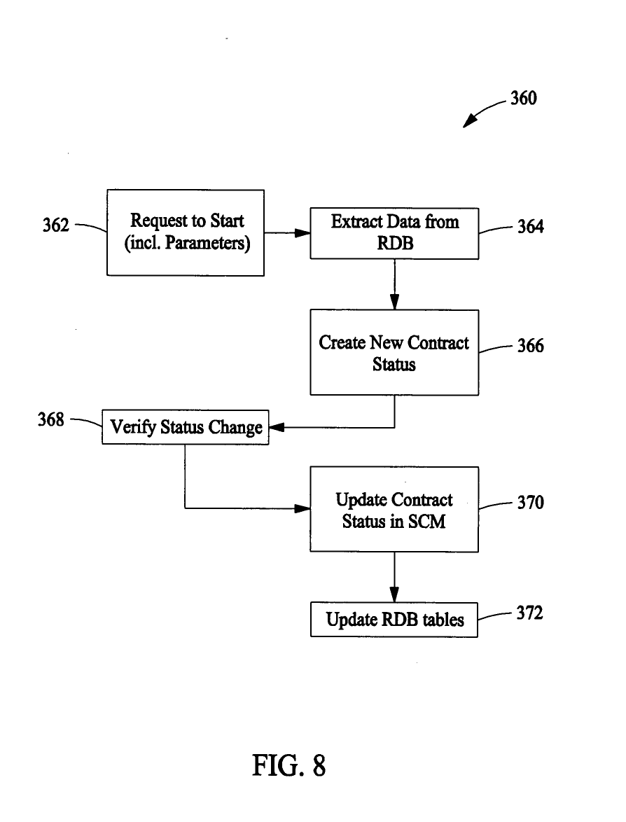

FIG. 8 is a flowchart 360 illustrating example processes utilized by Status Change Module (SCM) 202 (shown in FIG. 4). The technical effect of SCM 202 is achieved by a user first requesting 362 to start the SCM 202, which then causes data to be extracted 364 from RDB 218 (shown in FIG. 4). SCM 202 then creates 366 a new contract status, the status change is verified 368, and the contract status is updated 370 in SCM 202. The RDB tables are then updated 372 by SCM 202.

Input data for SCM 202 includes tables and fields from RDB 218. Output data from SCM 202 includes a Historical Exception Report, an Early Booking Report, and a Status 35 Report. The table and field parameters for input data and output data are set forth in Appendix A.

SCM 202 is an accounting engine as well as an enabling tool for the UEP Module 204 (shown in FIG. 4) and is part of AECS 10. SCM 202 uses RDB 218 as its data source. There are two distinct sets of functionality to be included. First, produce reverse bookings for all contracts in estimation status of 20. For example, if the contract status=20, for all bookings where booking currency=contract main currency, then create a reverse booking. Second, according to a set of triggers and business approval: (a) update the contract status of contracts in the RDB; and (b) update the Business table and generate new records for the Business Estimate table in the RDB. In the example embodiment, these two functions should run on a weekly basis, so that the underwriter can react to the results and the status is updated all the time.

With respect to step 362, a user can request a run of the SCM on an ad-hoc basis. At a minimum, it should be run once a quarter but expected frequency is once per week. The Status Change Algorithm (SCA) data set is defined as all Writasure contracts in the RDB with an underwriting year greater or equal to 1999. There are no contract status's associated with Writasure contract records in the RDB. Contracts with an underwriting year before 1999 will be automatically assigned a status of 40. In addition, all history should be run through the status change algorithm and an exception report produced of contracts and their status's as assigned by the SCA where the algorithm does not assign a status of 40. The results of this exception report may change the parameters of the data load.

With respect to step 364, data is extracted from RDB. Based on the parameters specified in Step 362, all data should be extracted.

With respect to step 366, SCM creates a new contract status. All contracts selected in Step 364 should be used as the data set to generate new statuses for the contracts as specified by the Status Change Algorithm.

With respect to step 372, SCM updates the RDB Tables. For every contract with a status change, a new/updated record needs to be entered into the RDB. A record showing the contract's current status needs to be inserted into the Business Estimation table via the RDB Business Estimate Interface and a record showing the contract's new status needs to be inserted into the Business_Attr_{—}2 interface via a CUWY (Current Underwriting Year) header interface.

In the example embodiment, contract status values include the following:

TABLE 1
Contract Status Values

| Contract Status | Definition |
|---|---|
| 10 | Not incepted status if today's date is less |
| | than contract inception date. |
| 20 | Estimation status if today's date is within |
| | risk or delay periods and the last premium |
| | installment not booked. |
| 35 | Exhausted status. Only relevant for |
| | Writasure Excess of Loss contracts. |
| | Contract in risk or delay period and claims |
| | limit is exceeded. |
| 40 | Booked status - Estimation and delay |
| | periods over, last premium installment |
| | booked. |
| 50, 60, 90 | Not relevant (cancelled or commuted |
| | contracts) |
| Null/blank | No assigned status (current state of all |
| | contracts) |

A contract status is recorded in three places: (1) in the SCM's Contract Status Change Fact table; (2) in the RDB Business_Attr_{—}2 table which reflects the current status of a contract; and (3) in the RDB Business_Est table which reflects the history of contract status changes. The last historical status can be seen by looking at the date of the record creation.

Permissible status changes are as follows:

| Old Status (same as RDB) | New Status (generated by SCA) |
|---|---|
| 10 | 20 |
| 20 | 35 |
| 20 | 40 |
| 35 | 40 |
| Blank | Any |

In the example embodiment, the status change algorithm (SCA) determines how these changes should take place. If the new status assigned is the same as the old status, no new status record needs to be generated.

The following includes a further explanation of the steps of the SCA.

Step: Inception/Expiry Date or Cover Basis Change in a Contract.

In this step, the system determines whether changes have been made to contracts in a status of 40. Because the RDB Business table does not track changes, such changes must be tracked within this application. Therefore, it is necessary to store inception date, expiry date, cover basis, and last updated date in the SCM. The record in the business table must be compared with the latest record from the SCM database (called Contract Status Fact for convenience). The latest record being the record that was last used to update a contract status in the RDB.

```
IF
((BUSINESS_ATTR_2.CUWY_STUS_C = 40)
AND
-- Contract Status Fact record corresponds to latest contract status and the RDB
Business table record has been updated since.
(BUSINESS.DATE_UPDATED > Contract Status Fact.Date_Updated)
AND
--inception date has changed
(
(Contract Status Fact.Inception Date != BUSINESS.CVF_D)
OR
-- or expiry date has changed
(Contract Status Fact.Inception Date != BUSINESS.CVT_D)
OR
-- or cover basis has changed
( IF BUSINESS.SRC_SYS_N = ‘WRITASURE’
    (BUSINESS_ADDL_WA.METH_PLACING_C=‘P%’ or ‘B% AND Contract
    Status  Fact.Cover  Basis  !=
    BUSINESS_ADDL_WA.PROP_COVER_BASIS_C)
    OR
    (BUSINESS_ADDL_WA.METH_PLACING_C=‘X% AND Contract Status
    Fact.Cover Basis != BUSINESS_ADDL_WA.XL_COVER_BASIS_C)
    OR
    ((BUSINESS_ADDL_WA.METH_PLACING_C =‘F%) AND Contract Status
    Fact.Cover Basis != BUSINESS_ATTR_2.CLMS_BSIS_C)
ELSE IF BUSINESS.SRC_SYS_N = ‘SICS’
        (Contract  Status  Fact.Cover  Basis  !=
    BUSINESS_ATTR_2.CLMS_BSIS_C)
)))
```

Step: In Risk Period.

There are three tests included within this step. The first test determines whether a contract is “Before Risk Period Not Incepted Status (Status 10)”. This test determines whether today's date is less than the contract's inception date (BUSINESS.CVF_D). The second test determines whether a contract is “During Risk Period Estimated Status (Status 20)”. A contract is in status 20 when today's date is greater or equal to the contract's inception date (BUSINESS.CVT_D) and less than or equal to the contract's Off-Estimation Date (calculated above). The third test determines whether a contract is “After Risk Period”. The test for after risk period is that today's date is greater than the Off-Estimation Date. Off-Estimation Date (also called Off-Risk Date) is a function of contract inception and expiry dates, and the contract's earning curve.

The algorithm for determining a Contract Earning Curve is as follows:

```
    if (BUSINESS.SRC_SYS_N = “Writasure”)
    (
        if ((contract.[AccountingBasis] in (‘A’, ‘P’, ‘R’))
        ((contract.[MoP]
        = “B*”)))
            Contract earning curve = S_function
        else
            Contract earning curve = Lin_function
}
    else if (contract.[SRC_SYS] = “SICS/CUWY”)
        if (BUSINESS_ATTR1. ORIG_TYP_OF_BUS_C = 1
            contract.[AccountingBasis] = “UNDER WRITING YR”) or
          (BUSINESS_ATTR1. ORIG_TYP_OF_BUS_C = 2
            contract.[ClaimBasis] “RA”)
            function = S_function
        else
            function = Lin_function
```

The algorithm for determining an Off-Estimation Date field in Contract Status Fact is as follows:

```
if ( Contract Status Fact.Earning Curve = S_function
    Contract Status Fact.Off Estimate Date = BUSINESS.CVT_D
        + ((BUSINESS.CVT_D − BUSINESS.CVF_D)+1
else if (Contract Status Fact.Earning Curve = Lin_function
    Contract Status Fact.Off Estimate Date = BUSINESS.CVT_D
```

Step: In Delay Period.

There is a standard delay period of 90 days for all contracts. The delay period is additional to the Off Estimation Date described above and is only used once today's date is greater than the Off Estimation Date. Therefore, it must be determined whether today's date is greater than 90 days after the contract's Off-Estimation Date. If it is, the delay period has finished; if not, it is in the delay period.

The delay period must be easily changeable as it is likely to be altered. The delay period should be able to be set by the user on demand so the module should be able to be run with a 180 delay period or a 360 day delay period.

Step: Determining Accounted Figures are Greater than EPI.

The sum of booked premiums to date must be compared to the EPI of a contract. EPI is dealt with differently for different types of business. For facultative contracts, the EPI amount is on a section level (many sections make up one contract) in the section currency. For EPI for Excess of loss, Proportional and Binding Authority EPI is on a contract level in contract currency. In both cases, premiums can be booked in contract/section currency and in other currencies (as specified by ACCOUNTING_DETAIL.ORIG_CUR_C). Therefore, a one to many relationship between EPI amounts and amounts of premium may exist.

For the purposes of comparison, all premiums and EPI amounts may be converted to United States Dollars (USD) and compared. There are two amount fields in the RDB.ACCOUNTING_DETAIL table, ORIG_CUR_A and GBL_A. The first contains amounts in original currency booked, the second contains a conversion to USD using monthly exchange rates (from the RDB.EXCHANGE_RATE table).

EPI in Writasure is stored in the BUSINESS_ADDL_WA table, the source field of the data varies according to type of business. Type of business can be determined from the METH_PLACING FIELD (used in the ‘Inception/Expiry Date or Cover basis change in a contract’ step).

| | Type of | | |
|---|---|---|---|
| METH_{—} | Business/ | | |
| PLACING_{—} | product | | EPI |
| C value | type | Source of EPI | Currency |
| P % | Proportional | PROP_EPI_SHARE_A | CUR_C |
| X % | Excess of | FAC_SUM_XLTTY | CUR_C |
| | Loss | DEPPREM_OS_A | |
| F % | Facultative | SEC_PRMSHR_A | SEC_CUR_C |
| B % | Binding | FAC_PRM_OUR_{—} | CUR_C |
| | Authority | SHARE_A | |

Where an EPI amount is not in USD (indicated by the relevant EPI Currency field), it should be converted and recorded for comparison purposes.

The following conditions are used for selecting movements from the Accounting Detail table:

| RDB table.attribute | Condition |
|---|---|
| ACCOUNTING_DETAIL.TRTY_NUM_I | = current |
| | contract |
| ACCOUNTING_DETAIL.UWG_YR_D | = underwriting |
| | year of contract |
| ACCOUNTING_DETAIL.BUS_DIM_I | = current contract |
| | bus_dim_I (business |
| | table primary key) |
| ACCOUNTING_DETAIL.ENTR_C | See below. |

EPI for Facultative contracts is worked out on a section by section basis. This involves working with more than one amount of EPI. It is therefore necessary to sum/compare premium bookings on a section level also. This can be done with data from the DTL_OBJ_REF table in the RDB.

The substring (DTL_OBJ_I, 28, 2) will give the section of a premium booking. The DTL_OBJ_REF table can be linked to the ACCOUNTING_DETAIL table by the DTL_REC_I. The bookings can then be joined to the subsection by TRTY_NUM_I, UWG_YR_D (called ACCDET_UWG_YR_D in the BUSINESS_ADDL_WA table) and SEC_C. SEC_C represents the contract section in the BUSINESS_ADDL_WA table.

A facultative contract still has to be considered at a contract level so it is only booked (status 40) once all contract installments are paid and total premiums exceed or are equal to total EPI for the contract. For Excess of Loss, Proportional and Binding Authority, Premium bookings are summed and the sum is compared to EPI on a contract level. The fields that contain booking amounts are ORIG_CUR_A (original booking currency) and GBL_A (USD) from ACCOUNTING_DETAIL.

Step: Determining if the Contract is a Writasure Contract.

This step is performed when running the SCM against contract data from multiple systems. This is done by checking if BUSINESS.SRC_SYS_N=‘WRITASURE’.

Step: Determining if Contract is Excess of Loss.

The type of business a contract is must be determined. This can be done using the Method of Placing codes described below. Type of business can be determined from a first character of BUSINESS_ADDL_WA.METH_PLACING_C.

| Code | Type of business |
|---|---|
| BMB, BMN | Binding Authority (not relevant) |
| FNB, FNC, FPB, FPC | Facultative (F) |
| LSB, LSC | Lineslip (not relevant) |
| PTB, PTC, PTO | Proportional (P) |
| XTB, XTC, XTO | Excess of Loss (X) |

Step: Determining if claim Limit Exceeded.

The ACCOUNTING_DETAIL.ORIG_CUR_A (claim amount in claim currency) of claims must be summed with the booking codes above for each excess of loss contract. This amount should be stored in the output data model. If this is greater than the claims limit, the contract is exhausted and must be assigned status 30. The Contract claims limit for Excess of Loss contracts can be found in BUSINESS_ADDL_WA.FAC_SUM_MAXLIMIT_A. It is in the contract main currency (BUSINESS_ADDL_WA.CUR_C).

The selection criteria for claims bookings for a contract are as follows.

| RDB table.attribute | Condition |
|---|---|
| ACCOUNTING_DETAIL.TRTY_NUM_I | = current contract |
| ACCOUNTING_DETAIL.UWG_YR_D | = underwriting year of |
| | contract |
| ACCOUNTING_DETAIL.BUS_DIM_I | = current contract bus_{—} |
| | dim_I (business |
| | table primary key) |
| DATE_AND_PERIOD.CMPR_D | See below |
| ACCOUNTING_DETAIL.ENTR_C | IN (‘2%’, ‘3%’, ‘4%’) |
| | excluding 4W for |
| | Writasure |

Claims bookings must be related to the current contract by contract number and underwriting year (can be done by business table primary key). Claims bookings are indicated by 2%, 3% and 4% Global (SICS) entry codes. Where source system is Writasure, booking code 4W is excluded.

Where a claim's currency (ACCOUNTING_DETAIL.ORIG_CUR_A) is not equal to the contract currency (BUSINESS_ADDL_WA..CUR_C), it should be converted using exchange rate data described below.

The claims limit (called FAC_SUM_MAXLIMIT_A) in the database is a positive figure in the database whilst claims totals are negative. The sum-total of claims should be multiplied by (−1). If it is greater or equal to the claims limit then the contract is in a status of 35, otherwise it is not.

Exchange rates should be taken from the RDB.EXCHANGE_RATE table. The current/latest month's (EXCH_RATE_D) exchange rate (EXCH_Z) should be taken for the currency (CUR_C).

Once all contract status updates are verified and updated in the SCM, the new records need to be added to the Business_Attr_{—}2 table and to the Business Estimate table. The database should be updated via the standard Information load procedures using the New Contract Status field as the source for new status data. Fixed length text files must be generated in order to do this, examples of which are included below.

The BUSINESS_ATTR_{—}2 contains current, valid data for each BUSINESS record (contract header). The BUSINESS_EST table contains history of changing attributes of each BUSINESS record. Note that it does not track history of all BUSINESS attributes.

There are two interfaces through which the RDB receives this data: (1) CUWY header interface for Business_attr2 updates, and (2) Business Estimate interface for business estimate updates. For the CUWY header interface, a file must be provided where every field reflects the current state of the contract in the RDB except the status field which should be populated with the new status. For the Business Estimate interface, a file must be provided where every field reflects the current state of the contract in the RDB including the current contract status. These interfaces extract data from flat files and insert into RDB tables.

II. Unearned Premium (UEP) Module

AECS 10 also includes Unearned Premium (UEP) Module 204 (shown in FIG. 4). The UEP Module is an accounting engine and is part of AECS 10. It produces the necessary adjustment bookings automatically to generate the U.S. GAAP figures. The UEP Module is for premium adjustments and commission adjustments only. Depending on the life-cycle of a contract, it replaces the booked figures with estimation bookings based on Ultimate Estimations from the Cedent or the Underwriter. For each contract/section/underwriting year, the Ultimate Estimated Premium (EPI) and the estimated Commission is spread over the period proportional to the underlying risk of getting claims. For different Types of Business, there are different “earning patterns” for how a premium is earned over the quarters. For example a “Clean-Cut” contract is linearly earned over the period.

Appendix B sets forth the inputs needed for the UEP Module to calculate premium and commission bookings. Appendix B also includes the output files for the LEP Module.

Generally, the user interface for the UEP Module includes three parts: (1) Enter Runtime Parameters, (2) Specify Input Data, and (3) Report Output Data.

Enter Runtime Parameters.

All necessary runtime parameters will be handed over by command line switches. For each run of the UEP Module, the following parameters need to be set:

| Parameter | Description | Mandatory |
|---|---|---|
| AsOfDate | Date as of which the calculations should | Yes |
| | be done. (Could be viewed as “today”). | |
| | Needed in both the Quarter and the | |
| | planning mode. | |
| CalcPeriodStartDate | Begin date of the period for which | Yes |
| | bookings are to be calculated | |
| | Needed only in case of planning mode | |
| CalcPeriodEndDate | End date of the period for which | Yes |
| | bookings are to be calculated. | |
| | Needed only in case of planning mode | |
| Mode | Mode of calculation: “Quarter Close | YES |
| | Mode” or “Planning Mode” | |

A Production mode will produced records that are posted into the Production RDB. This can be done by the normal load routine in the RDB.

Specify Input Data.

The specification of the input data to be used will be handed over by a command line switch. A well-formed input specification includes a set of zero or more input restrictions in the form SQL. Each restriction shall include:

| Element | Description | Example |
|---|---|---|
| Table Name | The input table on which | LAST_ULT_STUS |
| | the restriction is to be | |
| | applied | |
| SQL WHERE | The restriction | ORIG_BUS_REIR_C = 65 |
| Clause | | (Limits the Reinsurer) |

Report Output Data.

The output data will be stored in the respective Oracle® table(s). (Oracle is a registered trademark of Oracle Corporation, Redwood City, Calif.). Only users known to the system shall be able to run the calculations. This means that users have to be authorized and authenticated to utilize the UEP Module. Additionally, only specific users shall be able to trigger the further processing of output data into the production data warehouse (RDB)

The UEP Algorithm described below includes the following assumptions: a contract is basically a record in the table LAST_ULT_STUS; and the notation contract [Inceptiondate] refers to the respective attribute (INCP_D).

In the example embodiment, all the non-numeric fields out of Last_Ult_Status are required. Data has to exist for each record and has to be consistent. The validation should be done by database internal procedures.

The UEP Algorithm is as follows:

```
// Get all contracts as specified (InputRestrictions)
ResultSet resultSet = getContracts(LAST_ULT_STUS, InputRestrictions)
// For each contract:
while (resultSet.next( )) {
    // get the current contract from DB
    currentContract = new Contract(resultSet)
    if (currentContract.[ExpiryDate] = NULL]
currentContract.[ExpiryDate] =
  currentContract.[InceptionDate] + 365
    // Determine Earning Curves and derived Info
currentContract.lookupEarningCurve( ) // must be first!
currentContract.lookupDelayPeriod( )
currentContract.lookupOffEstimate( )
// Take care for contract status
oldStatus = currentContract.getStatus( )
newStatus = currentContract.calculateStatus( )
// save new status ????
// generate new UEP bookings
if (currentContract.QueryTotalAmountForBookingCode(‘PR’)
    > currentContract.[EPI]) {
currentContract.doTrueUp( )
}
else if ( newStatus = 20 ) {
    // distinguish if “Quarter Close Mode” or “planning mode”
currentContract.generateBookings<MODE>( )
}
// do true-up
else if ( newStatus in (30,40) and oldStatus = 20 )
currentContract.doTrueUp( )
}
} // end of while
```

Depending on the type of contract, different earning curves are to be applied for the calculations.

Available Earning Curves.

Earning curves may be changed (i.e., redefined) or new earning curves may be added for the UEP. Therefore, dynamic management of earning curves is needed. The following earning curves are currently defined within AECS 10:

```
Function Lin_funktion(contract, asOfDate)
    per = contract.[ExpiryDate] − contract.[InceptionDate] + 1
    ult = max( asOfDate − contract.[InceptionDate]+1, 0 )
    if (asOfDate < contract.[InceptionDate])
    return 0
    if (contract.[InceptionDate] <= asOfDate < contract.[ExpiryDate])
    return ult/per
    else
        return 1
    }
Function S_funktion(contract, asOfDate)
    per = contract.[ExpiryDate] − contract.[InceptionDate] + 1
    ult = max( asOfDate − contract.[InceptionDate]+1, 0 )
    // calc how long earning curve “lasts”
    endDate = contract.[ExpiryDate]
          + ((contract.[ExpiryDate] − contract.[InceptionDate])
    if (asOfDate < contract.[InceptionDate])
    return 0
    if (contract.[InceptionDate] <= asOfDate < contract.[ExpiryDate])
    return ((ult/per)\hat{ }2)/2
    if (contract.[ExpiryDate] <= asOfDate < endDate])
    return 1− [(2-(ult/per))\hat{ }2] / 2
    else
        return 1
    }
```

Determining the Earning Curve for a Contract.

The drivers for defining the earning curve type are variable.

```
contract.lookupEarningCurve( )
        EarningCurve function = null;
        if (contract.[SRC_SYS] = “Writasure”)
        if (contract.[AccountingBasis] in { “R”, “A”, “P”}) or
        (substr(contract.[MethodofPlacing],1,1)=‘B’
                        function = S_function
                else
                        function = Lin_function
        }
        else if (contract.[SRC_SYS] = “SICS/CUWY”)
                if (BUSINESS_ATTR1.SCREENTYPE=1 and
                        contract.[AccountingBasis] = “UNDERWRITING YR”) or
                  (BUSINESS_ATTR1.SCREENTYPE=2 and
                        contract.[ClaimBasis] “RA”)
                        function = S_function
                else
                        function = Lin_function
        }
        else
{
        log the erroneous contract
throw an Exception
}
        contract.setEarningCurve(function)
        return function
}
```

Determining Delayperiod for a Contract.

The DelayPeriod is an extra time after the application of an earning curve for a contract officially ends. This is done for safety reasons.

```
contract.lookupDelayPeriod( ) {
        delayPeriod = 100 // in days
        contract.setDelayPeriod (delayPeriod)
        return delayPeriod
}
                An alternative embodiment of the Delay Period
depends on an Earning Curve applied for a contract. For example,
        if ( contract.getEarningCurve( ) = S_function
        delayPeriod = 100
}
```

Determining OffEstimate Date for a Contract.

OffPeriod is basically the date from which all earnings have been fully assigned to a contract (i.e., when the earning curve is equal to 1 plus a grace period) determined by DelayPeriod.

```
contract.lookupOffEstimate( ) {
        Date OffEstimate = null
        if ( contract.getEarningCurve( ) = S_function
                OffEstimate = contract.[ExpiryDate]
                        + ((contract.[ExpiryDate] − contract.
                        [InceptionDate])
                        + contract.getDelayPeriod( )
        else if ( contract.getEarningCurve( ) = Lin_function
                OffEstimate = contract.[ExpiryDate]
                        + contract.getDelayPeriod( )
        }
        contract.setOffEstimate(OffEstimate)
        return OffEstimate
}
```

Contract Status is also calculated. According to the following algorithm, in the table LAST_ULT_STUS, the field CUWY_STATUS is set for all the affected contracts:

```
contract.calculateStatus(asOfDate) {
        status = 0
                if (asOfDate < contract.[InceptionDate])
                        status = 10
                else if ( asOfDate < contract.getOffEstimate( ) )
                        status = 20
                else // (asOfDate >= contract.getOffEstimate( ) )
                        status = 40
        If (contract.[src_sys] = “WriteAssure)
                        contract.setStatus(status)
        else
        if(Mode = PlanningMode)
        {
                if (asOfDate.year > current year)
                {
                        contract.setStatus(status)
        }
        else
                if (asOfDate.year == current year) and
                        asOfDate.quarter > current quarter)
                {
                        contract.setStatus(status)
                }
                else
                        if (status != contract.getOldStatus( ))
                        {
                                mark the contract with a flag stating the
                                mismatch between the calculated and the
                                old status
                                contract.setStatus(contract.getOldContractStatus)
                        }
}
else
        if (status != contract.getOldStatus( ))
        {
                mark the contract with a flag stating the
                mismatch between the calculated and the
                old status
                contract.setStatus(contract.getOldContractStatus)
        }
return contract.getStatus( )
}
```

The UEP Module also calculates bookings. The booking calculations can be categorized as: (1) Get booking code totals for a contract (Helper function for “Quarter Close Mode”); (2) Generate bookings in “Quarter Close Mode”; and (3) Generate bookings in “Planning Mode”.

The “Quarter Close Mode” calculates new bookings according to the difference between new estimations and existing bookings. The “Planning Mode” calculate new bookings according to the difference between estimations for the end and estimations for the beginning of the planning period.

Get Booking Code Totals for a Contract.

To generate the bookings for a contract in “Quarter Close Mode”, a contract's totals of existing bookings for a given list of booking codes are needed. The booking code can be either one of EP, NP, GP, EC, NC, GC or PR (all Writasure Premiums), CO (all Writasure Commissions). PR and CO do not exist as such but are represented by a number of different booking codes in Writasure. If they are not in Contract Main Currency, the bookings need to be re-evaluated using last rate in the quarter (current SAP P&L Rate).

```
contract.queryTotalAmountForBookingCode(bookingCode) {
        // translate summary codes (e.g. PR for all premium codes)
        listOfbookingCodes = getRealBookingCodes (bookingCode)
        // get booking code totals per currency for this contract
        ResultSet resultSet = query(
                “select sum(ORIG_CUR_A) as
                AMOUNT, ORIG_CUR_C as
                CURRENCY from ACCOUNTING_DETAIL
                where BUS_DIM_I = contract.[BUS_DIM_I]
                        and ENTR_C in listOfbookingCodes
                group by ORIG_CUR_C”
                )
        total = 0
        // For each currency total
        while (resultSet.next( )) {
                result = resultSet.currentRecord
                amount = result.[AMOUNT]
/**
```

Here it is to be checked that if the currency is other than the Main Currency and if the amount for that currency is not zero then the booking code, the amount, and the currency code have to be logged. But if the currency is matching with the Main Currency then have to return the amount.

```
*/
        If (result.[ORIG_CUR_C] != contract.[MainCurrency])
        {
                If (result.[Amount] ! =0)
                {
                log (Booking Code, the amount and the currency code)
                }
  }
  else
                total = amount
return total
}
```

Generate Bookings in “Quarter Close Mode”

As stated above, new bookings are calculated according to the difference between new estimations for the end date of the planning period and the existing bookings.

```
contract.generateBookingsInQuarterCloseMode( ){
        // the dates used
        per = contract.[ExpiryDate] − contract.[InceptionDate] + 1
        ult = max( asOfDate − contract.[InceptionDate], 0 )
        // get the existing booking totals -> could be combined
        PR1 = contract.queryTotalAmountForBookingCode ( “PR” )
        CO1 = contract.queryTotalAmountForBookingCode ( “CO” )
        EP1 = contract.queryTotalAmountForBookingCode ( “EP” )
        EC1 = contract.queryTotalAmountForBookingCode ( “EC” )
        NP1 = contract.queryTotalAmountForBookingCode ( “NP” )
        NC1 = contract.queryTotalAmountForBookingCode ( “NC” )
        GP1 = contract.queryTotalAmountForBookingCode ( “GP” )
        GC1 = contract.queryTotalAmountForBookingCode ( “GC” )
        EP2= contract.[EPI] − EP1 − PR1
        EC2= contract.[EstCommission] − EC1 − CO1
        insertBooking(contract, contract.[MainCurrency], “EP”, EP2)
        insertBooking(contract, contract.[MainCurrency], “EC”, EC2)
        If substr(contract.[MethodofPlacing],1,1)=’F’ {
                GP2=( Lin_funktion(contract, AsofDate) − 1 ) * (EP1 + EP2 +PR1) −
                                        GP1
                GC2=( Lin_funktion(contract, AsofDate) − 1 ) * (EC1 + EC2 +CO1) −
                                GC1
                insertBooking(contract, contract.[MainCurrency], “GP”, GP2)
                insertBooking(contract, contract.[MainCurrency], “GC”, GC2)
}
Else{
                NP2=( Lin_funktion(contract, AsofDate) − 1 ) * (EP1+ EP2 +PR1) −
        NP1
                NC2=( Lin_funktion(contract, AsofDate) − 1 ) * (EC1 + EC2 +CO1) −
                                NC1
        // save new bookings to ACCOUNTING_DETAILS
        insertBooking(contract, contract.[MainCurrency], “NP”, NP2)
        insertBooking(contract, contract.[MainCurrency], “NC”, NC2)
        // extra bookings for s-shape earning curves
        if ( contract.getEarningcurve( ) = S_function ){
        GP2 = (S_funktion(contract, AsofDate) − 1) * (EP1 + EP2 +PR1)
                                                        − NP1 − NP2 − GP1
        GC2 = (S_funktion(contract, AsofDate) − 1) * (EC1 + EC2 +CO1)
                                                        − NC1 − NC2 −GC1
        insertBooking(contract, contract.[MainCurrency], “GP”, GP2)
        insertBooking(contract, contract.[MainCurrency], “GC”, GC2)
                }
}
}
```

Generate Bookings in “Planning Mode”

In the Planning Mode, new bookings are calculated according to the difference between estimations for the end and estimations for the beginning of the planning period.

```
contract.generateBookingsInPlanningMode( ){
        // the dates used
        per = contract.[ExpiryDate] − contract.[InceptionDate] + 1
        ult = max( asOfDate − contract.[InceptionDate], 0 )
        prevDate(User Input)
        endDate (User Input)
        EP = contract.[EPI] − ORIG_EPI_A_B
        EC = contract.[EstCommission] − ORIG_COM_A_B
        insertBooking(contract, contract.[MainCurrency], “EP”, EP)
        insertBooking(contract, contract.[MainCurrency], “EC”, EC)
        If substr(contract.[MethodofPlacing],1,1 )=‘F’ {
                                      //“F” Stands for facultative
                GP=( Lin_funktion(contract, endDate) − 1 ) *
                contract.[EPI] − ( Lin_funktion(contract, prevDate) −
                1 ) * ORIG_EPI_A_B
                GC=( Lin_funktion(contract, endDate) − 1 ) *
        contract.[EstCommission] −
                ( Lin_funktion(contract, prevDate) − 1 ) *
                ORIG_COM_A_B
                insertBooking(contract, contract.[MainCurrency],
                “GP”, GP)
                insertBooking(contract, contract.[MainCurrency],
                “GC”, GC)
}
else {
NP=( Lin_funktion(contract, endDate) − 1 ) * contract.[EPI] −
        ( Lin_funktion(contract, prevDate) − 1 ) * ORIG_EPI_A_B
NC=( Lin_funktion(contract, endDate) − 1 ) * contract.
        [EstCommission] − ( Lin_funktion(contract,prevDate) − 1 ) *
        ORIG_COM_A_B
// save new bookings to ACCOUNTING_DETAILS
insertBooking(contract, contract.[MainCurrency], “NP”, NP)
insertBooking(contract, contract.[MainCurrency], “NC”, NC)
// extra bookings for s-shape earning curves
if ( contract.getEarningcurve( ) = S_function )
        GP=(S_funktion(contract, endDate)−1) * contract.[EPI] −
                (S_funktion(contract, prevDate)−1) *
                ORIG_EPI_A_B −NP
        GC=(S_funktion(contract, endDate)−1) * contract.
        [EstCommission] −(S_funktion(contract, prevDate)−1) *
                ORIG_COM_A_B −NC
        insertBooking(contract, contract.[MainCurrency], “GP”, GP)
        insertBooking(contract, contract.[MainCurrency], “GC”, GC)
        }
        }
}
```

The UEP Module also performs a “true-up” of all bookings. In the example embodiment, the algorithm used in performing the true-up is as follows:

```
EP = contract.queryTotalAmountForBookingCode ( “EP” )
EC = contract.queryTotalAmountForBookingCode ( “EC” )
NP = contract.queryTotalAmountForBookingCode ( “NP” )
NC = contract.queryTotalAmountForBookingCode ( “NC” )
GP = contract.queryTotalAmountForBookingCode ( “GP” )
GC = contract.queryTotalAmountForBookingCode ( “GC” )
If (EP!=0)
        EP=−EP
        insertBooking(contract, contract.[MainCurrency], “EP”, EP)
If (NP!=0)
        NP=−NP
        insertBooking(contract, contract.[MainCurrency], “NP”, NP)
If (GP!=0)
        GP=−GP
        insertBooking(contract, contract.[MainCurrency], “GP”, GP)
If (EC!=0)
        EC=−EC
        insertBooking(contract, contract.[MainCurrency], “EC”, EC)
If (NC!=0)
        NC=−NC
        insertBooking(contract, contract.[MainCurrency], “NC”, NC)
If (GC!=0)
        GC=−GC
        insertBooking(contract, contract.[MainCurrency], “GC”, GC)
```

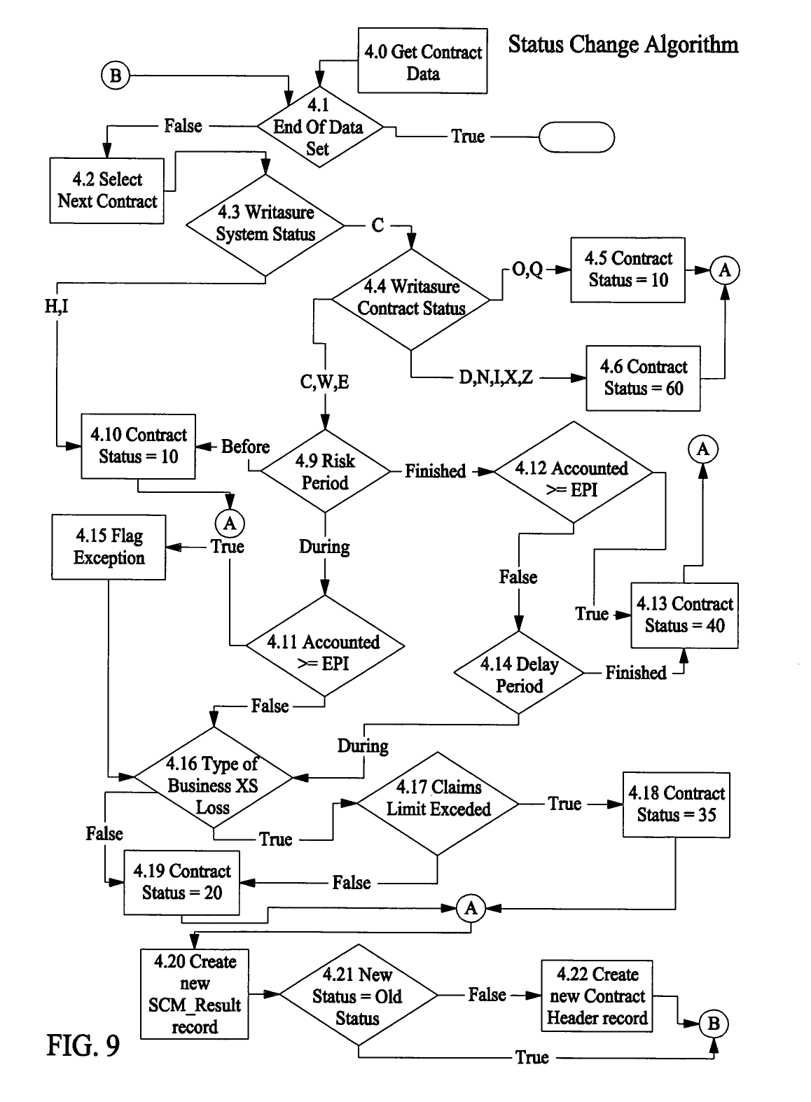

FIG. 9 is a is a more detailed flowchart 380 illustrating example processes utilized by Status Change Module (SCM) 202 (shown in FIG. 4). Flowchart 380 illustrates in more detail the example processes utilized by SCM 202 as generally shown in flowchart 360 (shown in FIG. 8).

III. RIP/RIOS Module

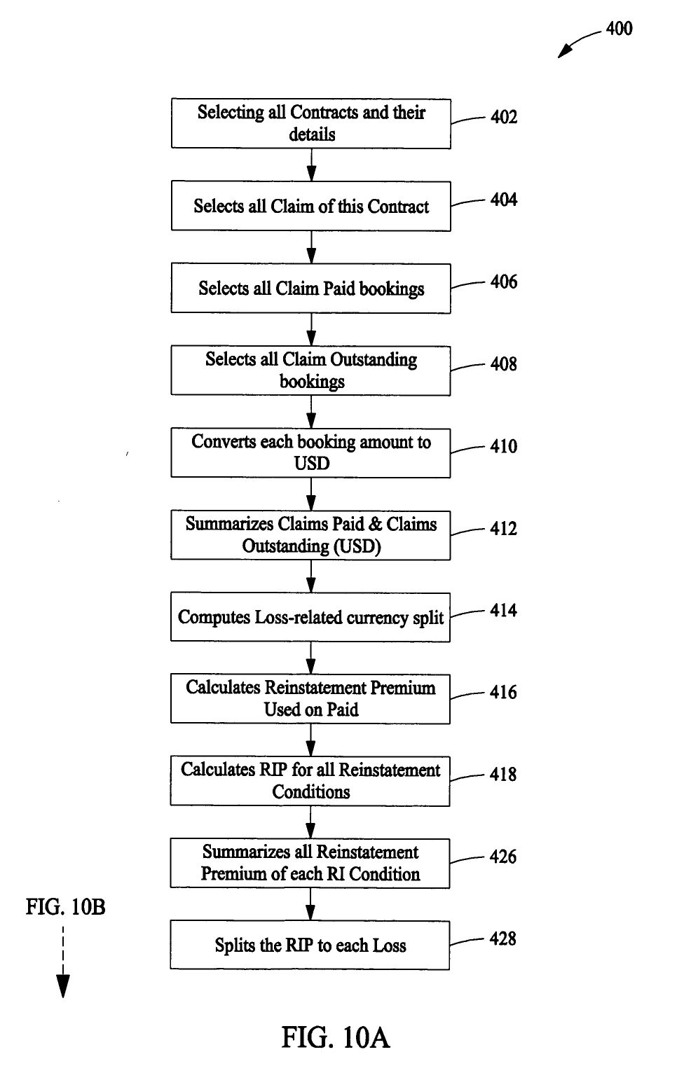

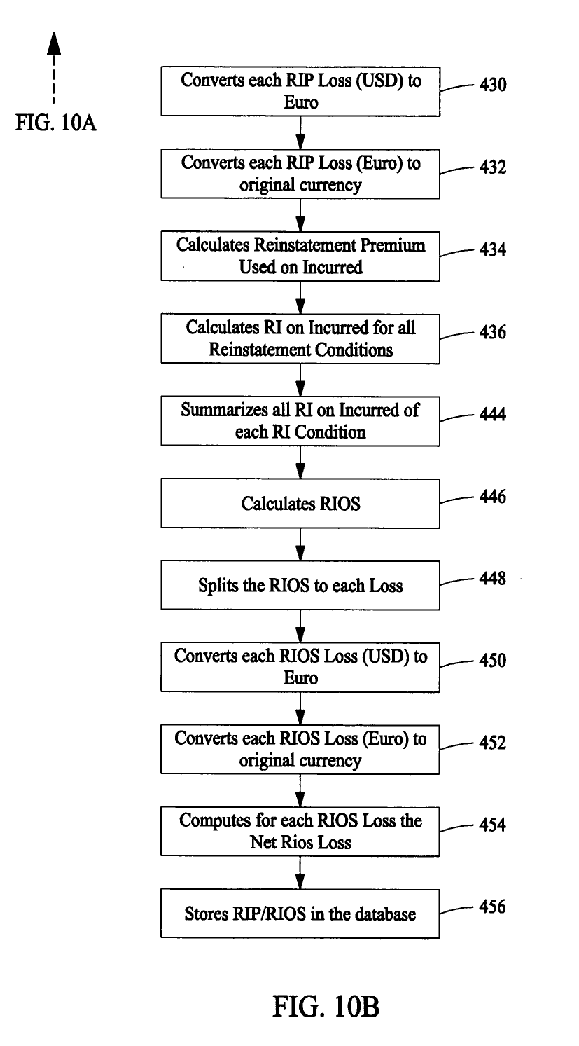

FIGS. 10A and 10B show a flowchart 400 illustrating example processes utilized by RIP/RIOS Module 208 (shown in FIG. 4). RIP/RIOS Module 208 includes an algorithm. The technical effect of the RIP/RIOS algorithm is achieved by a user first selecting 402 all Contracts and details within AECS 10 (shown in FIG. 1). For each Contract, the user then selects 404 all claims for the Contract, selects 406 all claim Paid bookings, selects 408 all claim Outstanding bookings, converts 410 each booking amount to USD, summarizes 412 claims Paid & claims Outstanding (USD), computes 414 Loss-related currency split, calculates 416 Reinstatement Premium Used on Paid, calculates 418 RIP for all Reinstatement Conditions, summarizes 426 all Reinstatement Premium of each RI Condition, splits 428 the RIP to each Loss, converts 430 each RIP Loss (USD) to Euro, converts 432 each RIP Loss (Euro) to original currency, calculates 434 Reinstatement Premium Used on Incurred, calculates 436 RI on Incurred for all Reinstatement Conditions, summarizes 444 all RI on Incurred of each RI Condition, calculates 446 RIOS, splits 448 the RIOS to each Loss, converts 450 each RIOS Loss (USD) to Euro, converts 452 each RIOS Loss (Euro) to original currency, computes 454 for each RIOS Loss the Net RIOS Loss, and stores 456 RIP/RIOS in the database.

For example, with respect to calculating RIP for all Reinstatement conditions, the system may calculate RIP of 1^{st} Reinstatement Condition, calculates RIP of 2^{nd} Reinstatement Condition, calculates RIP of 3^{rd} Reinstatement Condition, and calculates RIP of 4^{th} Reinstatement Condition. With respect to calculating RI on Incurred for all Reinstatement Conditions, the system may calculate RI on Incurred of 1^{st} Reinstatement Condition, calculates RI on Incurred of 2^{nd} Reinstatement Condition, calculates RI on Incurred of 3^{rd} Reinstatement Condition, and calculates RI on Incurred of 4^{th} Reinstatement Condition.

Application architecture and SQLs for the RIP/RIOS Module are set forth in Appendix C.

Each step of the RIP/RIOS algorithm will be discussed in more detail below.

Step 402, Select all Contracts and their details.
Select all CONTREF from Oracle Table CONTRACT_INDEX. For each of this Contract references (CONTREF) do
Select Contract details in Oracle Table CONTRACT_DETAIL where the contract primary keys are equal.
For example: SELECT CI.MAJORCLASS_NAME AS MAJORCLASS, CI.CONTRACT_NBR AS CONTRACT, CI.UWYR_YR AS UWYR, CI.VERSION_NAME AS VERSION, CI.ENDORSE_NAME AS ENDORSE, CI.CONTREF_ID AS CONTREF, CTR_DTL.MAXLIMIT_AMT AS MAXLIMIT, CTR_DTL.LIMITOS_AMT AS LIMITOS, CTR_DTL.PREMIUMOS_AMT AS PREMIUMOS, CTR_DTL.DEDUCKTOS_AMT AS DEDUCKTOS, CTR_DTL.QUOTESHARE_AMT AS QUOTESHARE, CTR_DTL.CONTRACTCURRENCY_CD AS CONTRACTCURRENCY, CTR_DTL.BROKER_NAME AS BROKER, CTR_DTL.CEDENT_NAME AS CEDENT, CTR_DTL.INCEPTIONDATE_DATE AS INCEPTIONDATE, CTR_DTL.EXPIRYDATE_DATE AS EXPIRYDATE FROM LTC_REPORT.CONTRACT_INDEX CI, LTC_REPORT.CONTRACT_DETAIL CTR_DTL
WHERE CTR_DTL.FK_LOAD ID=1 AND CTR_DTL.CONTRACT_NBR=5112 AND CTR_DTL.MAJORCLASS_NAME=‘N’ AND CTR_DTL.UWYR_YR=1999 and so on.

Step 404, Select all claims.
Select all claims in Oracle Table CLAIM where Contract Number, Major class, underwriting year, version, and endorsement are equal.
For example, SELECT
ID, CLAIMNO, DATEOFLOSS, CATCODE, PERIL, FK_CONTREF FROM LTC_REPORT.CLAIM
WHERE FK_CONTREF=‘N-000234-1999-0-00’

Step 406, Select all claim Paid bookings.
Select all claim paid bookings in Oracle Table CLAIMS_BOOKING_PAID where claim Number, Date of Loss and Peril is equal and the Cut Off Date is greater than the Billing date.
For example, SELECT ID, ORIGCCY, BILLMON, BILLYEAR, MOP, FK_CONTREF, FK_CLAIMNO, FK_DATEOFLOSS, FK_CATCODE FROM LTC_REPORT.CLAIMS_BOOKING_PAID

For Currency conversion in the Contract level, the Inception date is used as the exchange rate date. In the currency conversion in the Booking level, the user specified date is used. If the Inception date is less than or equal to 4th quarter 2000, Q4 2000 is used for Exchange rate calculation.

Step 408, Select all claim Outstanding bookings.
Select all claim paid bookings in Oracle Table CLAIMS_BOOKING_OS where claim Number, Date of Loss and Peril is equal and the Cut Off Date is greater than the Billing date.
For example, SELECT ID, ORIGCCY, BILLMON, BILLYEAR, MOP, FK_CONTREF, FK_CLAIMNO, FK_DATEOFLOSS, FK_CATCODE FROM LTC_REPORT.CLAIMS_BOOKING_OS

Step 410, Convert each booking amount to USD.
Booking amounts can have any currency. We summarize the bookings with the same currency of each loss. We have to convert the amounts to Euro and afterwards to USD. The currency exchange rate date is under discussion and currently fixed to Q2 2002.

Step 412, Summarize claims Paid, Outstanding & Incurred (USD).
Summarize all booking amount (USD)
claims Paid: sum of all bookings in the CLAIMS_BOOKING_PAID Table
claims Outstanding: sum of all bookings in the CLAIMS_BOOKING_OS Table
claims Incurred: sum of claims Paid & claims Outstanding

Step 414, Compute Loss-related currency split.
Divide the total sum of claim booking with the “normalized” loss amount. Compute the split for each currency in a loss separately. The sum of all splits must be 1.

Step 416, Calculate Reinstatement Used on Paid.
Take the sum of all paid claim Bookings and divide this with the Contracts LIMITOS. The resulting value is the Reinstatement Used on Paid.

Step 418, Calculate RIP for all Reinstatement Conditions (e.g., 1^{st}-4^{th} Reinstatement Condition).
Compare the Reinstatement Used on Paid with the 1^{st} Reinstatement Condition Number.
If the Reinstatement Used on Paid is greater than the absolute of the 1^{st} RI number, then
   1^{st} RIP=Premium*absolute of 1^{st} RI number*1^{st} RI percentage/100 else consider the premium share of absolute Reinstatement Used on Paid:
   1^{st} RIP=Premium*absolute of Reinstatement Used on Paid*1^{st} RI percentage/100
For example, 1^{st} RI number=1; 1^{st} RI percentage=110; Premium=$174,983.00; claims Paid=$231,275.72; Reinstatement Used on Paid=6.313;
   6.313>1: 1^{st} RIP=$174,983.00*1.1=$192,481.30

Calculate RIP of 2^{nd} Reinstatement Condition.
Compare the Reinstatement Used on Paid with the 1^{st} Reinstatement Condition Number.
If the Reinstatement Used on Paid is less than the 1^{st} RI number, then the 2^{nd} RIP is 0.
Else
If the absolute of RI Used Paid is greater than the absolute of (1^{st} RI number+2^{nd} RI number), then
   2^{nd} RIP=Premium*absolute 2^{nd} RI number*2^{nd} RI percentage/100 else consider the premium share of Reinstatement Used on Paid:
   2nd RIP=Premium*RI Used Paid*2nd RI percentage/100
For example, 1^{st} RI number 1; 1^{st} RI percentage=110; Premium=$174,983.00; 2^{nd} RI Number=2; 2^{nd} RI Percentage=120; claims Paid=$231,275.72; RI Used Paid₂=5.313=6.313−1;
   6.313>1 and
   5.313>2: 2^{nd} RIP=$174,983.00*1.2*2=$419,959.20

Calculate RIP of 3^{rd} Reinstatement Condition.
Compare the Reinstatement Used on Paid with the 1^{st} Reinstatement Condition Number.
If the Reinstatement Used on Paid is less than the 1^{st} RI number, then the 3^{rd} RIP is 0.
Else
If the RI Used Paid3 is greater then the absolute of (1^{st} RI number+2^{nd} RI number+3^{rd} RI number), then
   3^{rd} RIP=Premium*absolute 3^{rd} RI number*3^{rd} RI percentage/100 else consider the premium share of Reinstatement Used on Paid:
   3^{rd} RIP=Premium*RI Used Paid*3^{rd} RI percentage/100
For example, 1^{st} RI number=1; 1^{st} RI percentage=110; Premium=$174,983.00; 2^{nd} RI Number=2; 2^{nd} RI Percentage=120; 3^{rd} RI Number=3; 3^{rd} RI Percentage=100; claims Paid=$231,275.72; RI Used Paid₃=3.313=6.313−1−2;
   6.313>1 and
   3.313>3: 3^{rd} RIP=$174,983.00*1.0*3=$524,949.00

Calculate RIP of 4^{th} Reinstatement Condition.
Compare the Reinstatement Used on Paid with the 1^{st} Reinstatement Condition Number.
If the Reinstatement Used on Paid is less than the 1^{st} RI number, then the 4^{th} RIP is 0.
Else
If the RI Used Paid₄ is greater then the absolute of the 1^{st} RI number+2^{nd} RI number+3^{rd} RI number+4^{th} RI number), then
   4^{th} RIP=Premium*absolute 4^{th} RI number*4^{th} RI percentage/100 else consider the premium share of Reinstatement Used on Paid:
   4^{th} RIP=Premium*RI Used Paid*4^{th} RI percentage/100
For example, 1^{st} RI number=1; 1^{st} RI percentage=110; Premium=$174,983.00; 2^{nd} RI Number=2; 2^{nd} RI Percentage=120; 3^{rd} RI Number=3; 3^{rd} RI Percentage=100; 4^{th} RI Number=1; 4^{th} RI Percentage=100; claims Paid=$231,275.72; RI Used Paid₄=0.313=6.313−1−2−3;
   6.313>1 and
   0.313>1: FALSE 4^{th} RIP=$174,983.00*1.0*1*0.313=$54,769

Step 426, Summarize all Reinstatement Premium of each RI Condition.
Summarize all RIPs of each Reinstatement Condition
For example, 1^{st} RIP=$192,481.30; 2^{nd} RIP=$419,959.20; 3rd RIP=$524,949.00; 4^{th} RIP=$54,769;
Total RIP=1,192,158.50

Step 428, Split RIP to each Loss.
Divide the RIP (USD) through each Loss share (claims Split)
For example, Loss 1=0.6; Loss 2=0.4; RIP=100
RIP_{Loss 1}=100*0.6=60; RIP_{Loss 2}=100*0.4=40

Step 430, Convert each RIP Loss to Euro.
Divide each RIP Loss (USD) with the USD/EUR exchange rate.

Step 432, Convert each RIP Loss (Euro) to original currency.
Multiply each RIP Loss (EUR) with the EUR/Original Currency exchange rate.

Step 434, Calculate Reinstatement Used on Incurred.
Take the sum of all paid & outstanding claim Bookings and divide this with the Contracts LIMITOS. The resulting value is the Reinstatement Used on Incurred.

Step 436, Calculate RI on Incurred for all Reinstatement Conditions (e.g., 1^{st}-4^{th} Reinstatement Condition).
Compare the Reinstatement Used on Incurred with the 1^{st} Reinstatement Condition Number.
If the absolute Reinstatement Used on Incurred is greater then the 1^{st} RI number, then
   1^{st} RI on Incurred=Premium*absolute of 1^{st} RI number*1^{st} RI percentage/100
else consider the premium share of Reinstatement Used on Incurred:
   1^{st} RI on Incurred=Premium*absolute of RI Used on Incurred*1^{st} RI percentage/100
For example, 1^{st} RI number=1; 1^{st} RI percentage=110; Premium=$174,983.00; claims Incurred=$303,144.59; Reinstatement Used on Incurred=8.2759;
   8.2759>1: 1^{st} RI on Incurred=$174,983.00*1.1=$192,481.30

Calculate RI on Incurred of 2^{nd} Reinstatement Condition.
Compare the Reinstatement Used on Incurred with the 1st Reinstatement Condition Number.
If the absolute of Reinstatement Used on Incurred is less than the 1^{st} RI number, then the 2^{nd} RI on Incurred is 0.
Else
If the absolute of RI Used Inc is greater then the absolute of the sum of 1^{st} RI and 2^{nd} RI number, then
   2^{nd} RI on Incurred=Premium*absolute of 2^{nd} RI number*2^{nd} RI percentage/100
else consider the premium share of Reinstatement Used on Incurred:
   2^{nd} RI on Incurred=Premium*RI Used Inc*2^{nd} RI percentage/100
For example, 1^{st} RI number=1; 1^{st} RI percentage=110; Premium=$174,983.00; 2^{nd} RI Number=2; 2^{nd} RI Percentage=120; claims Incurred=$303,144.59; RI Used Inc 2=7.2759=6.313−1;
   8.2759>1 and
   7.2759>2+1:2^{nd} RI on Incurred=$174,983.00*1.2*2=$419,959.20

Calculate RI on Incurred of 3^{rd} Reinstatement Condition.
Compare the Reinstatement Used on Incurred with the 1^{st} Reinstatement Condition Number.
If the Reinstatement Used on Incurred is less than the 1^{st} RI number, then the 3^{rd} RI on Incurred is 0.
Else
If the absolute of RI Used Inc₃ is greater then the absolute of the sum of 1^{st} RI and 2^{nd} RI number and 3^{rd} RI number, then
   3^{rd} RI on Incurred=Premium*absolute of 3^{rd} RI number*3^{rd} RI percentage/100
else consider the premium share of Reinstatement Used on Incurred:
   3^{rd} RI on Incurred=Premium*RI Used Inc*3^{rd} RI percentage/100
For example, 1^{st} RI number=1; 1^{st} RI percentage=110; Premium=$174,983.00; 2^{nd}
RI Number=2; 2^{nd} RI Percentage=120; 3^{rd} RI Number=3; 3 RI Percentage=100; claims Incurred=$303,144.59;
RI Used Inc ₃=5.2759=8.2759−1−2;
   8.2759>1 and
   5.2759>3^{rd} RI Number: 3^{rd} RI on Incurred=$174,983.00*1.0*3=$524,949.00

Calculate RI on Incurred of 4^{th} Reinstatement Condition.
Compare the Reinstatement Used on Incurred with the 1^{st} Reinstatement Condition Number.
If the Reinstatement Used on Incurred is less than the 1^{st} RI number, then the 4^{th} RI on Incurred is 0.
Else
If the absolute of the RI Used Inc₄ is greater than the absolute of the sum of 1^{st} RI and 2^{nd} RI number and 3 RI number and 4 RI number, then
   4^{th} RI on Incurred=Premium*absolute of 4^{th} RI number*4^{th} RI percentage/100
else consider the premium share of Reinstatement Used on Incurred:
   4^{th} RI on Incurred=Premium*RI Used Inc*4^{th} RI percentage/100
For example, 1^{st} RI number=1; 1^{st} RI percentage=110; Premium=$174,983.00; 2^{nd} RI Number=2; 2^{nd} RI Percentage=120; 3^{rd} RI Number=3; 3^{rd} RI Percentage=100; 4^{th} RI Number=0; 4^{th} RI Percentage=0; claims Incurred=$303,144.59; RI Used Inc₂=7.2759=8.2759−1;
RI Used Inc₄=2.2759=8.2759−1−2−3;
   8.2759>1 and
   2.2759>4^{th} RI Number: 4^{th} RI on Incurred=$174,983.00*0*0=0

Step 444, Summarize all Reinstatement Premium of each RI Condition.
Summarize all Reinstatement Premiums on Incurred of each Reinstatement Condition 1^{st} RI on Incurred=$192,481.30; 2^{nd} RI on Incurred=$419,959.20; 3^{rd} RI on Incurred=$524,949.00; 4^{th} RI on Incurred=$0;
Total RI on Incurred=$1,137,389.50

Step 446, Calculate RIOS.
RIOS is the subtraction of the Total Reinstatement Premiums Incurred and Total RIP (USD)
For example, Total RIP=$121,420.10, Total RI Incurred=$159,151.36; RIOS=$37,731.26

Step 448, Split RIOS to each Loss.
Divide the RIOS (USD) through each Loss share (claims Split)
For example, Loss 1=0.6; Loss 2=0.4; RIP=100
RIOS_{Loss 1}=100*0.6=60; RIOS_{Loss 2}=100*0.4=40

Step 450, Convert each RIOS Loss to Euro.
Divide each RIOS Loss (USD) with the USD/EUR exchange rate.

Step 452, Convert each RIOS Loss (Euro) to original currency.
Multiply each RIOS Loss (EUR) with the EUR/Original Currency exchange rate.

Compute the NetRatio.
Net Ratio=(EPI_AMT−EPI_CONTRCALC_USD_AMT)/EPI_AMT
In the case the EPI_AMT is NULL or ‘0’ then the NetRatio is not calculated and it is explicitly set to ‘1’.
If the EPI_CONTRCALC_USD_AMT is NULL then it is taken as ‘0’.
For example, Contref_id=‘C-000855-1997-0-00’; EPI_AMT=1003270.8; EPI_CONTRCALC_USD_AMT=250817.69
NetRatio=0.75

Compute the Net RIP.
If The sum (Premium shares)=0 or sum(Premium shares)=NULL
   Then calculate Net RIP=Rip Split of the claim*Net Ratio
Else
   NETRIP=TOTALRIPUSD (RIP split of a claim)
For example, NetRatio=0.75; TotaIRIP=$17622.64;
NETRIP=$13216.98;
   Compute the Net RIOS
If The sum (Premium shares)=0 or sum(Premium shares)=NULL
   Then calculate Net RIOS=Rios Split of the claim*Net Ratio
Else
   NETRIOS=TOTALRIOSUSD (Rios Split of a claim.)
For example, NetRatio=0.75; TotalRIOS=$0;
NETRIOS=$0

Compute the Currency/CatCode Split NetRip Amount.
If the NETRIP value exist in the RIP_RIOS_RESULT table
Then Currency/catcode Split NetRip Amount=Amount (Currency Split)*Net ratio
The ritype would be stored as NETRIP for this record in the RIP_RIOS_RESULT_CURRENCY_SPLIT table
For example, NetRatio=0.75; Amount (Currency Split)=$32254.64; Currency/catcode Split NetRip Amount=$24190.98

Compute the Currency/CatCode Split NetRios Amount.
If the NETRIOS value exist in the RIP_RIOS_RESULT table
Then Currency/catcode Split NetRios Amount=Amount (Currency Split)*Net ratio
The ritype would be stored as NETRIOS for this record in the RIP_RIOS_RESULT_CURRENCY_SPLIT table
For example, NetRatio=0.75; Amount (Currency Split)=$21211.11; Currency/catcode Split NetRios Amount=$159.09

Step 456, Store RIP/RIOS in the database.
A record gets inserted into the AESESSION table with details for the current calculator run. This records provides the calculator with the session Id which is the reference for all the other output tables.
Store each contract RIP/RIOS/NETRIP/NETRIOS Totals in USD in the Oracle Table RIP_RIOS_RESULT. This would be linked to the AESESSION table with the fk_session foreign key.
Store each RIP/RIOS/NETRIP/NETRIOS currency split in the table RIP_RIOS_RESULT_CURRENCY_SPLIT and build a Foreign Key relationship to RIP_RIOS_RESULT
Store each contract RIP/RIOS movements in USD in the Oracle Table AE_BOOKING. The movements would be for INWARD and OUTWARD RIP/RIOS values. This would be linked to the AESESSION table with the fk_session foreign key N:1 relation.

IV. IBNR Module

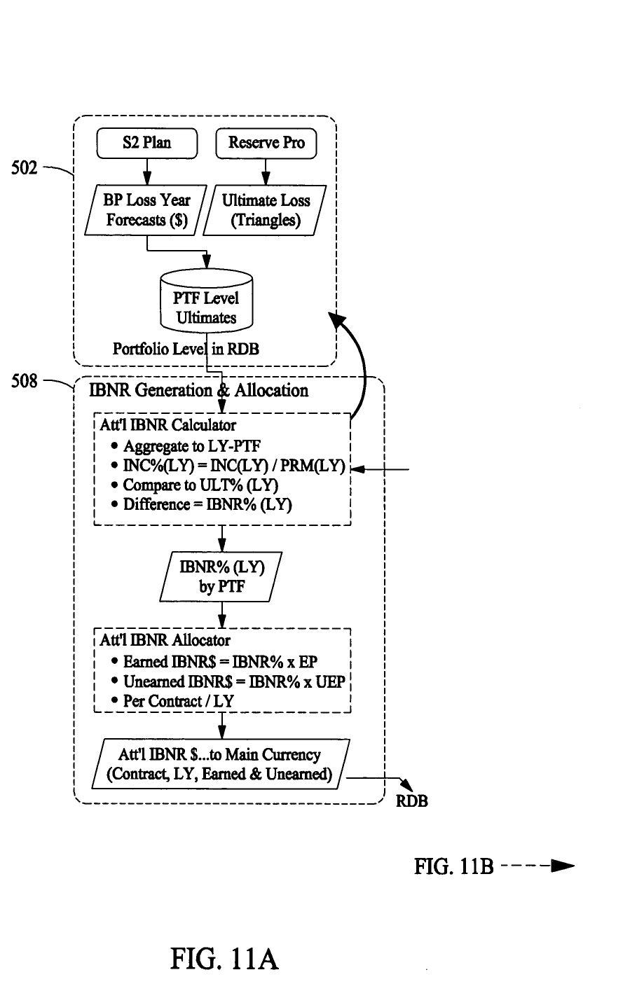

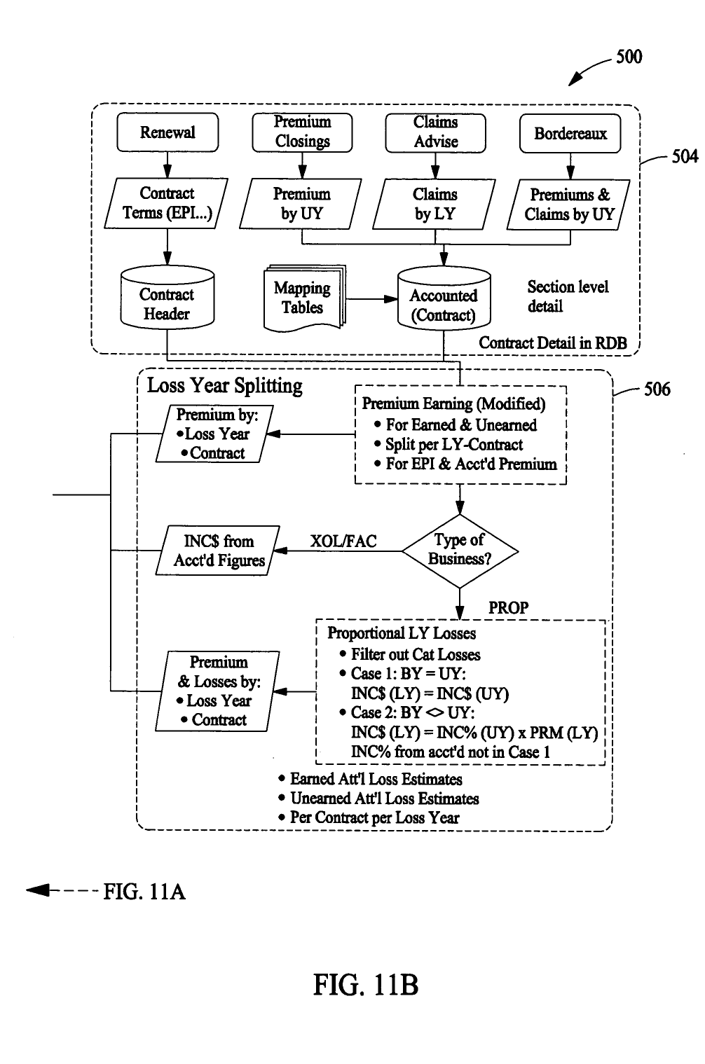

FIG. 11 is a flowchart 500 illustrating example processes utilized by IBNR Module 214 (shown in FIG. 4). Flowchart 500 includes four separate operations: ultimate loss ratios entry module 502, extraction and aggregation of contract data on booking code group level 504, loss year splitting 506, and IBNR generation and allocation 508.

In the example embodiment, ultimate loss ratios entry module 502 involves the preparation and storage of the ultimate loss ratios as show in FIG. 11. A history of ultimate loss ratios per portfolio is stored in the system. An Intranet GUI interface (Loss Ratio Entry Module) is provided to view and update a table manually using data coming either from a Session 2 Plan or a Reserve Pro Studies. Access rights to the table will allow privileges for viewing and writing. Users with write access will be able to update the ultimate loss ratio for any portfolio at any time. Each table entry will contain the portfolio name, loss ratio, date, and user ID of the person making the update. In another embodiment, ultimate loss ratios entry module 502 may be expanded to include a CAT Ultimate (IBNR) tool.

In the example embodiment, extraction and aggregation of contract data on booking code group level 504 involves the extraction of the contract header and booking data from RDB. Required RDB data is split by at least one of: Contract, Contract section, Booking code Group, Booking Year and Month, German GAAP Revenue Year, Cat code, and claims number. The booking code groups used are modified ACE code groups: (e.g. PR, EP, RIP, CO, PC, Incurred claims (CL, OS, IB) similar to BP_Label detail).

In the example embodiment, information required for loss year splitting 506 for accounting engines includes only premiums and claims. For a Reserve Pro feed, all of the following information is needed. Loss year splitting information includes: (1) Premium (M&D, Adjustment Premium, Additional Premium), Deductions (Brokerage, Commission, PC, NCB), but not RIP/RIOS, which are split according to risk period (similar to US GAAP earning) and use functions from UEP module; (2) claims wherein no split is necessary and wherein claims information is booked in RDB via Writasure (loss year, catcode, claim number, date of loss); (3) Unearned premium booking codes; and (4) RIP/RIOS (not split by LY splitter).

In the example embodiment, IBNR generation and allocation 508 involves currency conversion, aggregating to portfolio level by ACE booking code, IBNR calculation, incurred ratio calculation, and IBNR ratio calculation. Currency conversion involves converting original amounts into USD using common rate, and changing currency table for the IBNR module once a year (1Q every year). Aggregating to portfolio level by ACE booking code results in a balance per code/portfolio/loss year in USD. For IBNR calculation, only PR+EP (ultimate premium), NP+GP (unearned premium), CL, OS is needed.

The calculation of Incurred Ratio is as follows:

$$Incurred \% = \frac{CL + OS + IBC}{PR + PRA + EP + NP + GP}$$

(booked loss year incurred claims over earned loss year premium)

The calculation of IBNR ratio is as follows:
IBNR %=Max(0,Ultimate_LR %−Incurred %) for current year and IBNR %=(Ultimate_LR %−Incurred %) for prior year
Zero IBNR if Inc %>Ultimate % for current year IBNR$=IBNR %*(PR+PRA+EP+NP+GP) for all loss years

AECS therefore enables a business entity involved in the insurance industry to collect, manage, store, calculate, and disseminate accounting engine (AE) information among internal users and selected outside users to facilitate a more accurate and efficient compliance with the reporting requirements of U.S. GAAP. In the example embodiment, the AECS collects, tracks, displays, calculates, and disseminates near-real time AE information. In addition, the AECS includes a plurality of accounting engine modules including at least one of a Status Change Module, an Unearned Premium (UEP) Module, a Commissions Module, a Reinstatement Premium/Reinstatement Outstanding (RIP/RIOS) Module, an Attritional Loss Module, a Catastrophic Loss Module, and an Incurred But Not Reported (IBNR) Module. The accounting engine modules calculate estimated results on single contracts and portfolios, and appropriate quarterly accruals in accordance with U.S. GAAP accounting requirements. The AECS also records the entries in a general ledger. The AECS utilizes the concepts of the earning of premiums, commissions, and losses for various kinds of contracts and business transactions in performing such calculations. The AECS also includes a true up/status change functionality that replaces estimated numbers with real accounted numbers as soon as the real accounted numbers are reliable and booked within the operating system. The AECS also calculates retrocessions.

The systems and processes described herein are not limited to the specific embodiments described herein. Moreover, the systems and processes described herein are not limited to the insurance industry. In fact, the AECS may be utilized by any industry or business that is required to comply with U.S. GAAP. More specifically, the AECS may be utilized by any industry or business that engages in business outside of the United States and is required to collect, track, and disseminate business information in compliance with U.S. GAAP, for example, when preparing and reporting its financial statements. Such business information includes at least one of accounts receivable data, accounts payable data, accounting data, operating metrics, cash flow data, financial statements, capital structure, income statements, collateral data, guarantors, claims, accruals, losses, and other documents and information relating to the financial condition of the business.

For example, businesses engaged in business outside of the United States that are required to report financial results in compliance with U.S. GAAP include businesses in at least one of the following industries: banking, financial, manufacturing, distribution, and other industries. The AECS enables these types of businesses to compare economic forecasts to actual economic numbers, and translates the results into U.S. GAAP standards for reporting purposes within the United States.

For example, with respect to the financial and/or banking industries, a user may utilize the AECS for lending purposes, leasing purposes, booking contracts, posting general reserves for losses and/or gains, and posting specific reserves as the portfolio and individual assets deteriorate or perform better than expected for the business.

With respect to the manufacturing and distribution industry, a user may utilize the AECS for purchasing raw materials and inventories for production where it is possible that such inventories may deteriorate or go out of date prior to or after the manufacturing process, due to distribution or shelf life issues.

With respect to other industries, a user may utilize the AECS for processing accounts receivables, accounts payables, aging accounts receivables, reducing accounts receivables based on prescribed polices and regulatory standards, credit evaluation, credit granting, customer collection and account reconciliation, remittance processing, posting journal entries to the general ledger system of the business, and reporting financial information.

While the invention has been described in terms of various specific embodiments, those skilled in the art will recognize that the invention can be practiced with modification within the spirit and scope of the claims.

1. A method for calculating estimated results and accruals on at least one insurance contract in accordance with predetermined accounting principles using a plurality of accounting engines in communication with a database, said method comprising:
storing insurance information in the database, wherein the insurance information relates to the at least one insurance contract issued by an insurer to an insured, and includes information relating to at least one of premiums, commissions, insurance policies, contracts, accounting bookings, claims, accruals, and losses;
transmitting insurance information from the database to the plurality of accounting engines;
calculating at the accounting engines estimated results and accruals for the at least one insurance contract in accordance with the predetermined accounting principles;
generating entries for recording in a general ledger of the insurer based on the calculated estimated results and accruals; and
recording the entries in the general ledger of the insurer.

2. A method in accordance with claim 1 wherein storing insurance information in the database further comprises:
storing insurance information in an operating system;
transmitting insurance information from the operating system to a reporting database; and
reconciling the insurance information communicated between the operating system and the reporting database.

3. A method in accordance with claim 1 wherein storing insurance information in the database further comprises:
transmitting insurance information from an operating system to a reporting database;
transmitting insurance information from the reporting database to a transactional database; and
transmitting insurance information from the transactional database to the plurality of accounting engines.

4. A method in accordance with claim 1 wherein calculating at the accounting engines estimated results and accruals further comprises calculating at the accounting engines estimated results and accruals for the at least one insurance contract in accordance with predetermined accounting principles wherein the accounting engines include at least one of a status change engine, an unearned premium engine, a commissions engine, a reinstatement premium/reinstatement outstanding engine, an attritional loss engine, a catastrophic loss engine, and an incurred but not reported engine.

5. A method in accordance with claim 1 wherein calculating at the accounting engines estimated results and accruals further comprises:
providing a plurality of accounting engines including a status change engine, an unearned premium engine, and a reinstatement premium/reinstatement outstanding engine;
utilizing the status change engine to determine whether a status change has occurred with an insurance contract;
transmitting insurance information from the status change engine to the unearned premium engine if the status change engine determines that a change has occurred in the status of the insurance contract; and
transmitting insurance information from the status change engine to the reinstatement premium/reinstatement outstanding engine if the status change engine determines that a change has not occurred in the status of the insurance contract.

6. A method in accordance with claim 5 wherein utilizing the status change engine further comprises enabling the insurer to replace estimated numbers included within the insurance information with accounted numbers when the accounted numbers are reliable and booked within the database.

7. A method in accordance with claim 1 wherein calculating at the accounting engines estimated results and accruals further comprises:
receiving insurance information at the plurality of accounting engines including an unearned premium engine;
calculating premium and commission bookings in accordance with the predetermined accounting principles using a predetermined algorithm executed within the unearned premium engine; and
recording the calculated bookings in the general ledger of the insurer.

8. A method in accordance with claim 7 wherein calculating premium and commission bookings further comprises calculating premium and commission bookings based on estimations received from an underwriter.

9. A method in accordance with claim 1 wherein calculating at the accounting engines estimated results and accruals further comprises:
receiving insurance information at the plurality of accounting engines including a reinstatement premium/reinstatement outstanding engine;
calculating loss related premium components including at least one of a reinstatement premium and a reinstatement outstanding premium in accordance with predetermined accounting principles using a predetermined algorithm executed within the reinstatement premium/reinstatement outstanding engine; and
recording the calculated loss related premium components in the general ledger of the insurer.

10. A method in accordance with claim 1 wherein calculating at the accounting engines estimated results and accruals further comprises:
receiving catastrophic loss estimates at a catastrophic loss engine from at least one of underwriters and actuarials; and
recording the calculated catastrophic loss estimates in the general ledger of the insurer.

11. A method in accordance with claim 1 wherein calculating at the accounting engines estimated results and accruals further comprises calculating at the accounting engines estimated results and accruals for a portfolio of insurance contracts in accordance with predetermined accounting principles.

12. A method in accordance with claim 1 wherein calculating at the accounting engines estimated results and accruals further comprises:
receiving insurance information relating to a portfolio per lossyear of insurance contracts at the plurality of accounting engines including an incurred but not reported engine;
calculating attritional loss estimates on a portfolio level in accordance with predetermined accounting principles using a predetermined algorithm executed within the incurred but not reported engine;
allocating the attritional loss estimates from a portfolio level to a contract level; and
recording the calculated attritional loss estimates on a contract level in the general ledger of the insurer.

13. A method in accordance with claim 1 wherein calculating at the accounting engines estimated results and accruals further comprises calculating at the accounting engines estimated results and accruals for the at least one insurance contract in accordance with United States Generally Accepted Accounting Principles.

14. A system for calculating estimated results and accruals on at least one insurance contract in accordance with predetermined accounting principles, said system comprising:
a database for storing insurance information relating to the at least one insurance contract issued by an insurer to an insured, and to at least one of premiums, commissions, insurance policies, contracts, accounting bookings, claims, accruals, and losses; and
a plurality of accounting engines in communication with said database, said accounting engines configured to:
receive insurance information from said database;
calculate estimated results and accruals for the at least one insurance contract in accordance with the predetermined accounting principles;
generate entries for recording in a general ledger of the insurer based on the calculated estimated results and accruals; and
record the entries in the general ledger of the insurer.

15. A system in accordance with claim 14 wherein said database comprises a reporting database, said database configured to:
receive insurance information at said reporting database from an operating system; and
reconcile the insurance information communicated between the operating system and said reporting database.

16. A system in accordance with claim 14 wherein said database comprises a reporting database and a transactional database, said database configured to:
receive insurance information at said reporting database from an operating system;
transmit insurance information from said reporting database to said transactional database; and
transmit insurance information from said transactional database to said accounting engines.

17. A system in accordance with claim 14 wherein said plurality of accounting engines comprises at least one of a status change engine, an unearned premium engine, a commissions engine, a reinstatement premium/reinstatement outstanding engine, an attritional loss engine, a catastrophic loss engine, and an incurred but not reported engine.

18. A system in accordance with claim 14 wherein said plurality of accounting engines comprises a status change engine, an unearned premium engine, and a reinstatement premium/reinstatement outstanding engine, wherein said status change engine configured to:
determine whether a status change has occurred with an insurance contract;
transmit insurance information to said unearned premium engine if a change has occurred in the status of the insurance contract; and
transmit insurance information to said reinstatement premium/reinstatement outstanding engine if a change has not occurred in the status of the insurance contract.

19. A system in accordance with claim 18 wherein said status change engine further configured to replace estimated numbers included within the insurance information with accounted numbers when the accounted numbers are reliable and booked within said database.

20. A system in accordance with claim 14 wherein said plurality of accounting engines comprises an unearned premium engine configured to:
receive insurance information;
calculate premium and commission bookings in accordance with the predetermined accounting principles using a predetermined algorithm executed within said unearned premium engine; and
record the calculated bookings in the general ledger of the insurer.

21. A system in accordance with claim 20 wherein said unearned premium engine is further configured to calculate premium and commission bookings based on estimations received from an underwriter.

22. A system in accordance with claim 14 wherein said plurality of accounting engines comprises a reinstatement premium/reinstatement outstanding engine configured to:
receive insurance information;
calculate loss related premium components including at least one of a reinstatement premium and a reinstatement outstanding premium in accordance with predetermined accounting principles using a predetermined algorithm executed within said reinstatement premium/reinstatement outstanding engine; and
record the calculated loss related premium components in the general ledger of the insurer.

23. A system in accordance with claim 14 wherein said plurality of accounting engines comprises a catastrophic loss engine configured to:
receive catastrophic loss estimates from at least one of underwriters and actuarials; and
record the calculated catastrophic loss estimates in the general ledger of the insurer.

24. A system in accordance with claim 14 wherein said plurality of accounting engines are further configured to calculate estimated results and accruals for a portfolio of insurance contracts in accordance with predetermined accounting principles.

25. A system in accordance with claim 14 wherein said plurality of accounting engines comprises an incurred but not reported engine configured to:
receive insurance information relating to a portfolio per lossyear of insurance contracts;
calculate attritional loss estimates on a portfolio level in accordance with predetermined accounting principles using a predetermined algorithm executed within said incurred but not reported engine;
allocate the attritional loss estimates from a portfolio level to a contract level; and
record the calculated attritional loss estimates on a contract level in the general ledger of the insurer.

26. A system in accordance with claim 14 wherein the predetermined accounting principles comprise United States Generally Accepted Accounting Principles.

27. A computer program embodied on a computer readable medium for calculating estimated results and accruals on at least one insurance contract in accordance with predetermined accounting principles, said program comprising a code segment that receives insurance information and then:
maintains a database by adding, deleting and updating insurance information relating to the at least one insurance contract issued by an insurer to an insured, and to at least one of premiums, commissions, insurance policies, contracts, accounting bookings, claims, accruals, and losses;
supports a plurality of accounting engines that receive insurance information from said database;
calculates estimated results and accruals for the at least one insurance contract in accordance with the predetermined accounting principles;
generates entries for recording in a general ledger of the insurer based on the calculated estimated results and accruals; and
records the entries in the general ledger of the insurer.

28. A computer program in accordance with claim 27 further comprising a code segment that:
enables a user to store insurance information in an operating system;
transmits insurance information from the operating system to a reporting database; and
reconciles the insurance information communicated between the operating system and the reporting database.

29. A computer program in accordance with claim 27 further comprising a code segment that:
transmits insurance information from an operating system to a reporting database;
transmits insurance information from the reporting database to a transactional database; and
transmits insurance information from the transactional database to the plurality of accounting engines.

30. A computer program in accordance with claim 27 further comprising a code segment that supports a plurality of accounting engines including at least one of a status change engine, an unearned premium engine, a commissions engine, a reinstatement premium/reinstatement outstanding engine, an attritional loss engine, a catastrophic loss engine, and an incurred but not reported engine.

31. A computer program in accordance with claim 27 further comprising a code segment that:
utilizes a status change engine to determine whether a status change has occurred with an insurance contract;
transmits insurance information from the status change engine to an unearned premium engine if the status change engine determines that a change has occurred in the status of the insurance contract; and
transmits insurance information from the status change engine to a reinstatement premium/reinstatement outstanding engine if the status change engine determines that a change has not occurred in the status of the insurance contract.

32. A computer program in accordance with claim 27 further comprising a code segment that:
calculates premium and commission bookings in accordance with the predetermined accounting principles using a predetermined algorithm executed within an unearned premium engine; and
records the calculated bookings in the general ledger of the insurer.

33. A computer program in accordance with claim 32 further comprising a code segment that calculates premium and commission bookings based on estimations received from an underwriting user.

34. A computer program in accordance with claim 27 further comprising a code segment that:
calculates loss related premium components including at least one of a reinstatement premium and a reinstatement outstanding premium in accordance with predetermined accounting principles using a predetermined algorithm executed within a reinstatement premium/reinstatement outstanding engine; and
records the calculated loss related premium components in the general ledger of the insurer.

35. A computer program in accordance with claim 27 further comprising a code segment that:
receives catastrophic loss estimates at a catastrophic loss engine from at least one of underwriters and actuarials; and
records the catastrophic loss estimates in the general ledger of the insurer.

36. A computer program in accordance with claim 27 further comprising a code segment that:
receives insurance information relating to a portfolio per lossyear of insurance contracts at the plurality of accounting engines including an incurred but not reported engine;
calculates attritional loss estimates on a portfolio level in accordance with predetermined accounting principles using a predetermined algorithm executed within the incurred but not reported engine;
allocates the attritional loss estimates from a portfolio level to a contract level; and
records the calculated attritional loss estimates on a contract level in the general ledger of the insurer.

37. A computer program in accordance with claim 27 further comprising a code segment that calculates estimated results and accruals for the at least one insurance contract in accordance with United States Generally Accepted Accounting Principles.

38. A method for calculating estimated results and accruals for a business entity in accordance with predetermined accounting principles using at least one accounting engine in communication with a database, said method comprising:
storing business information in the database including at least one of accounts receivable data, accounts payable data, operating metrics, cash flow data, financial statements, capital structure, income statements, collateral data, guarantors, claims, accruals, losses, and other information relating to the financial condition of the business;
transmitting business information from the database to the at least one accounting engine;
calculating at the accounting engine estimated results and accruals for the business in accordance with the predetermined accounting principles;
generating entries for recording in a general ledger of the business based on the calculated estimated results and accruals; and
recording the entries in the general ledger of the business.

39. A method in accordance with claim 38 wherein storing business information in the database further comprises storing business information in the database for a business engaged in business activities outside of the United States wherein the business is further required to publicly disclose financial information relating to the business within the United States in accordance with the predetermined accounting principles.

40. A method in accordance with claim 39 wherein storing business information in the database further comprises:
storing business information in an operating system;
transmitting business information from the operating system to a reporting database; and
reconciling the business information communicated between the operating system and the reporting database.

41. A method in accordance with claim 39 wherein storing business information in the database further comprises:
transmitting business information from an operating system to a reporting database;
transmitting business information from the reporting database to a transactional database; and
transmitting business information from the transactional database to the at least one accounting engine.

42. A method in accordance with claim 39 wherein calculating at the accounting engine estimated results and accruals for the business further comprises enabling the business to replace estimated accounting numbers included within the business information with accounted numbers when the accounted numbers are reliable and booked within the database.

43. A method in accordance with claim 39 wherein calculating at the accounting engine estimated results and accruals for the business further comprises:
calculating income and gains for the business from business activities engaged in outside of the United States in accordance with the predetermined accounting principles using a predetermined algorithm executed within the accounting engine; and
recording the calculated income and gains for the business from business activities engaged in outside of the United States in the general ledger of the business.

44. A method in accordance with claim 43 wherein calculating income and gains further comprises calculating income and gains based on estimations generated by the business.

45. A method in accordance with claim 39 wherein calculating at the accounting engine estimated results and accruals for the business further comprises:
calculating expenses and losses for the business from business activities engaged in outside of the United States in accordance with the predetermined accounting principles using a predetermined algorithm executed within the accounting engine; and
recording the calculated expenses and losses for the business from business activities engaged in outside of the United States in the general ledger of the business.

46. A method in accordance with claim 45 wherein calculating expenses and losses further comprises calculating expenses and losses based on estimations generated by the business.

47. A method in accordance with claim 39 wherein calculating at the accounting engine estimated results and accruals for the business further comprises calculating at the accounting engine estimated results and accruals for a portfolio of assets owned by the business in accordance with predetermined accounting principles.

48. A method in accordance with claim 39 wherein calculating at the accounting engine estimated results and accruals for the business further comprises calculating at the accounting engine estimated results and accruals for the business in accordance with United States Generally Accepted Accounting Principles.

49. A system for calculating estimated results and accruals for a business entity in accordance with predetermined accounting principles, said system comprising:
a database for storing business information including at least one of accounts receivable data, accounts payable data, operating metrics, cash flow data, financial statements, capital structure, income statements, collateral data, guarantors, claims, accruals, losses, and other information relating to the financial condition of the business; and
at least one accounting engine in communication with said database, said accounting engine configured to:
receive business information from said database;
calculate estimated results and accruals for the business in accordance with the predetermined accounting principles;
generate entries for recording in a general ledger of the business based on the calculated estimated results and accruals; and
record the entries in the general ledger of the business.

50. A system in accordance with claim 49 wherein said database further includes business information relating to a business engaged in business activities outside of the United States wherein the business is further required to publicly disclose financial information relating to the business within the United States in accordance with the predetermined accounting principles.

51. A system in accordance with claim 50 wherein said database comprises a reporting database, said database configured to:
receive business information at said reporting database from an operating system; and
reconcile the business information communicated between the operating system and said reporting database.

52. A system in accordance with claim 50 wherein said database comprises a reporting database and a transactional database, said database configured to:
receive business information at said reporting database from an operating system;
transmit business information from said reporting database to said transactional database; and
transmit business information from said transactional database to said accounting engine.

53. A system in accordance with claim 50 wherein said accounting engine is further configured to replace estimated accounting numbers included within the business information with accounted numbers when the accounted numbers are reliable and booked within said database.

54. A system in accordance with claim 50 wherein said accounting engine is configured to:
calculate income and gains for the business from business activities engaged in outside of the United States in accordance with the predetermined accounting principles using a predetermined algorithm; and
record the calculated income and gains for the business from business activities engaged in outside of the United States in the general ledger of the business.

55. A system in accordance with claim 54 wherein said accounting engine is further configured to calculate income and gains based on estimations generated by the business.

56. A system in accordance with claim 50 wherein said accounting engine is further configured to:
calculate expenses and losses for the business from business activities engaged in outside of the United States in accordance with the predetermined accounting principles using a predetermined algorithm; and
record the calculated expenses and losses for the business from business activities engaged in outside of the United States in the general ledger of the business.

57. A system in accordance with claim 56 wherein said accounting engine is further configured to calculate expenses and losses based on estimations generated by the business.

58. A system in accordance with claim 50 wherein said accounting engine is further configured to calculate estimated results and accruals for a portfolio of assets owned by the business in accordance with the predetermined accounting principles.

59. A system in accordance with claim 50 wherein the predetermined accounting principles comprise United States Generally Accepted Accounting Principles.
